(19) United States
(12) Patent Application Publication
(10) Pub. No.: US 2013/0205277 A1
(43) Pub. Date: Aug. 8, 2013

(54) ENVIRONMENT AND METHOD FOR CROSS-PLATFORM DEVELOPMENT OF SOFTWARE APPLICATIONS

(71) Applicant: Telerik, AD, Sofia (BG)

(72) Inventors: Douglas Michael Seven, Sammamish, WA (US); Stefan Kanchev Dobrev, Sofia (BG); Evgeni Ivanov Petrov, Plovdiv (BG); Deyan Georgiev Varchev, Sofia (BG); Yavor Sashov Georgiev, Vidin (BG); Clemri Steyn, Redmond, WA (US)

(73) Assignee: Telerik, AD, Sofia (BG)

(21) Appl. No.: 13/657,149

(22) Filed: Oct. 22, 2012

Related U.S. Application Data
(60) Provisional application No. 61/642,187, filed on May 3, 2012.
(60) Provisional application No. 61/595,945, filed on Feb. 7, 2012.

(51) Int. Cl. G06F 9/44

(52) U.S. Cl. CPC G06F 8/70
USPC 717/121

(57) ABSTRACT

A method may include obtaining content files, where the content files include one or more presentation files, where each presentation file includes respective instructions which, when interpreted at runtime by a separate computing device, are configured to provide at least one of (a) a functionality and (b) a user interface of a software application executing upon the separate computing device. The method may include providing the content files to the separate computing device. After providing the content files, the method may include identifying a change in at least a first presentation file, and providing at least the first presentation file to the separate computing device, where the software application is configured to execute the first presentation file as at least one of (a) the functionality and (b) the user interface of the software application without need for re-installing or re-loading the software application on the separate computing device.

### RELATED APPLICATIONS

The present application claims priority to U.S. Provisional Application No. 61/595,945 entitled “Environment and Method for Development of Software for Wireless Computing Devices” and filed Feb. 7, 2012, and U.S. Provisional Application No. 61/642,187 entitled “Environment and Method for Development of Software for Wireless Computing Devices” and filed May 3, 201.2, the contents of each of which are hereby incorporated by reference in their entireties.

### BACKGROUND

Wireless computing devices may include, in some examples, cellular phones, smart phones, personal digital assistants, portable multimedia players, and tablet computers. Software applications may be downloaded to run on a wireless computing device. In some implementations, Web-based application stores may provide device-specific, platform-specific, or operating system-specific software application downloads to wireless computing devices.

### SUMMARY

in some implementations, the present disclosure may be directed to environments and methods for development of software for computing devices. The development process, in some implementations, may include cross-platform development of a software application for deployment on two or more computing device platfborms. A computing device platform, in some examples, may refer to a particular set of configuration parameters such as one or more of a device operating system (e.g., Microsoft® Windows® by Microsoft Corporation of Redmond, Wash., Linux™, Apple® Mac™ OS by Apple Inc, of Cupertino, Calif., Research in Motion (RIM) Blackberry® OS by Research in Motion Limited of Waterloo, Ontario, etc.), an operating system version, a device application format (e.g., Apple® iOS™ by Apple Inc., Android™ by Google Inc. of Menlo Park, Calif., Windows® Phone by Microsoft Corporation, Palm™ webOS™ by Hewlett-Packard Company of Palo Alto, Calif. Symbian™ by Accenture PLC of Dublin, Ireland, Bada™ by Samsung Electronics of Seoul, S. Korea, etc.), and a device peripheral configuration (e.g., input and output devices such as, in some examples, sensors, speakers, microphones, virtual and/or miniaturized keyboard, buttons and other physical control inputs, etc.).

As described herein, an integrated cloud environment (ICE), in some implementations, may provide an interface for developing a cross-platform software application that may be compiled to run on two or more computing device platforms. In some implementations, an integrated cloud environment may include features for designing, constructing, compiling, testing, and/or distributing software applications for a number of wireless computing device platformis. In some implementations, the integrated cloud environment may additionally provide features for designing, constructing, compiling testing, and/or distributing software applications for web-based applications (e.g., browser-based Web applications, applications compatible with Facebook® by Facebook, Inc. of Cambridge, Mass., server-side Web applications such as ASP.NET by Microsoft, etc.). The integrated cloud environment, in some implementations, may provide a developer with a development environment that is removed from individual software development kits (SDKs) or integrated development environments (IDEs) (e.g., xCode™ by Apple, Inc., Eclipse by the Eclipse Foundation of Ottawa, Canada, Visual Studio® by Microsoft, Rational Application developer for WebSphere® software by International Business Machines Corp. (IBM) of Armonk, N.Y., etc.) and/or programming languages (e.g., Objective-C, Java, C#, etc.) typically used for developing software applications for various platforms of wireless computing devices and Web applications. In some implementations, an integrated cloud environment for development of cross-platform software applications may involve an application developer interface installed on a local development computing device for developing and simulating a platform-independent version of the cross-platform software application. The integrated cloud environment for development of cross-platform software applications, in some implementations, may involve an application developer interface presented to a developer through an Internet browser program. The application developer interface may provide the developer with a communication channel to an integrated cloud environment for compiling the platform-independent development files with platform-specific files, for example using aspects of various software development kits or integrated development environments provided for application development towards specific computing device platforms.

In some implementations, cross-platform development for various computing devices may be enabled through an abstraction layer that allows the developer to define much of the behavior of an application through non-compiled resource files (e.g., “presentation files” as used herein), such as, in some examples, mark-up languages such as HyperText Markup Language (HTML), interpreted languages such as JavaScript, and style sheet languages such as Cascading Style Sheets (CSS). The presentation files, for example, may include commands for interacting with device peripherals, such as sensors, controls, and input/output mechanisms. In some implementations, the presentation files may further include commands for interacting with Web-based services such as device or platform-specific application programming interfaces (APIs). In some implementations, the abstraction layer for translating presentation files to platform-specific wireless computing device commands may be developed using the Apache Cordova platform by the Apache Software Foundation of Forest Hill, Md.

The presentation files, in some implementations, may be interpreted at runtime on the computing device to enable interactions between a user and the computing device. In some implementations, the presentation files may be interpreted by a browser engine feature of the computing device. In some implementations, the presentation files may be provided for presentation in a “windowless” (e.g., full screen, without defining browser border, etc) web-browser interface rendered upon the computing device. In some implementations, the presentation files may be combined with a number of media files, such as audio, image, and video files that may be accessed and presented during execution of the application through links to the media files incorporated in the presentation files. The combination of the media files and the presentation files, in some implementations, may be referred to as the “content files” of the cross-platform application project.

In one aspect, the present disclosure is directed to a method including obtaining, by a processor of a computing device, a number of content files, where the content files include one or more presentation files, where each presentation file of the one or more presentation files includes respective instructions which, when interpreted at runtime by a processor of a separate computing device, are configured to provide at least one of (a) a functionality and (b) a user interface of a software application executing upon the separate computing device. The method may further include providing the content files to the separate computing device. After providing the content files, the method may further include identifying, by the processor of the computing device, a change in at least a first presentation file of the number of presentation files, and providing at least the first presentation file to the separate computing device, where the software application is configured to execute the first presentation file as at least one of (a) the functionality and (b) the user interface of the software application without need for re-installing or re-loading the software application on the separate computing device.

In some embodiments, the content files further include one or more media files. The respective instructions, when interpreted at runtime, may be configured to provide the user interface of the software application within a browser application. The browser application may be configured to be invisible to the user.

In some embodiments, providing the content files may include pushing the content files to the separate computing device from the computing device via a wireless connection. Providing the content files may include uploading, to a network storage region accessible to the separate computing device, the content files. Providing the content files may include providing, for download, an installation executable containing the content files.

The installation executable may include a windowless browser application. The installation executable may include an update agent, where the update agent is configured, during execution of the software application, to receive one or more additional content files, where at least one of the one or more additional content files includes a replacement file for a first content file of the content files, and replace the first content file with the replacement file. The update agent may be further configured to, after replacing the first content file with the replacement file, refresh a current user interface of the software application to utilize the replacement file.

In some embodiments, the method may further include presenting a simulation of the software application within a mobile device simulator, where the mobile device simulator interprets the instructions of at least one of the one or more presentation files to simulate functionality of the software application upon a mobile device. The mobile device simulator may include one or more controls, where the one or more controls, when activated by a user of the computing device, are configured to supply input to the software application. The method may further include receiving, via a first control of the one or more controls, an orientation input and, responsive to the orientation input, changing an orientation of a display portion of the mobile device simulator.

The method may further include receiving, via a first control of the one or more controls, a device type input and, responsive to the device type input, modifying an appearance of the device simulator, where the device simulator includes a mobile device frame and a display area. The method may further include, responsive to the device type input, refreshing a current user interface presented by the mobile device simulator. The method may further include identifying, by the processor of the computing device, a change in at least a second presentation file of the number of presentation files, and refreshing a current user interface presented by the mobile device simulator to include information from the second presentation file.

In some embodiments, providing the first presentation file to the separate computing device includes providing the first presentation file responsive to receiving a request from a user of the computing device. The request may identify one or more computing devices, where the one or more computing devices includes the separate computing device.

The method may further include, prior to providing the content files, preparing an installation file including the content files. Preparing the installation file may include adding a digital signature to the installation file.

In some embodiments, the method further includes storing the content files in a version-controlled project directory. The method may further include receiving, at a storage address, a request for at least the first presentation file, where providing the first presentation file includes providing the first presentation file for download at the storage address. The storage address may include a URL. Providing the first presentation file may include opening a file update connection with the second computing device. The second computing device may execute the software application within a previously installed windowless browser application.

In one aspect, the present disclosure is directed to a method including obtaining, by a processor of a computing device, a number of content files, where the content files include one or more presentation files. The method may include accessing, by a companion application executing on the computing device, the number of content files; and interpreting, by the companion application, at least a first presentation file of the one or more presentation files, where interpreting the first presentation file includes rendering at least one of (a) a functionality and (b) a user interface of a software application. The method may include identifying, by the companion application, a request to obtain one or more replacement content files, and, responsive to the request, accessing, by the companion application, at least a first replacement presentation file, where the first replacement presentation file is configured to replace the first presentation file. The method may include refreshing, by the companion application, a user interface of the software application to present information interpreted from the first replacement presentation file.

In some embodiments, the request includes a gesture performed upon a touch screen interface of the separate computing device. The request may include scan data obtained through scanning, by a scan feature of the separate computing device, machine readable indicia. The scan data may include a network address. Accessing the replacement presentation file may include accessing a network address to obtain the replacement presentation file. The companion application may include a windowless browser, where the user interface of the software application is rendered within the windowless browser.

In one aspect, the present disclosure is directed to a system including a processor and a non-transitory computer readable medium storing a set of instructions that, when executed by the processor, cause the processor to obtain a number of content files, where the content files include one or more presentation files, where each presentation file of the one or more presentation files includes respective instructions which, when interpreted at runtime by a processor of a separate computing device, are configured to provide at least one of (a) a functionality and (b) a user interface of a software application executing upon the separate computing device. The instructions, when executed, may cause the processor to provide the content files to a number of separate computing devices, and, after providing the content files, identify a change in at least a first presentation file of the number of presentation files, and provide at least the first presentation file to at least a first computing device of the number of separate computing devices, where the software application is configured to execute the first presentation file as at least one of (a) the functionality and (b) the user interface of the software application without need for re-installing or re-loading the software application.

In some embodiments, the first computing device is in communication with the system via a wired connection. Providing the at least the first presentation file may include providing the at least first presentation file to a second computing device, where the second computing device is in coimmunication with the system via a wireless connection. The instructions, when executed, may further cause the processor to, prior to providing the at least first presentation file, identify at least one computing device of the number of computing devices on a wireless network, where the at least one computing device includes the first computing device. Providing the first presentation file to the first computing device may include providing the first presentation file across the wireless network. Providing the first presentation file to the first computing device may include opening a file sharing connection with a download agent executing upon the first computing device.

In some embodiments, the system further includes an input device, where the instructions, when executed, further cause the processor to, prior to providing the at least first presentation file, receive, via the input device, an indication of at least one computing device of the number computing devices, where the at least one computing device includes the first computing device. Providing the first presentation file may include providing the first presentation file, responsive to the indication, to the at least one computing device.

In one aspect, the present disclosure is directed to a non-transitory computer readable medium storing a set of instructions that, when executed by a processor, cause the processor to obtain a number of content files, where the content files include one or more presentation files, where each presentation file of the one or more presentation files includes respective instructions which, when interpreted at runtime by a processor of a separate computing device, are configured to provide at least one of (a) a functionality and (b) a user interface of a software application executing upon the separate computing device. The instructions, when executed, may further cause the processor to provide the content files to the separate computing device and, after providing the content files, identify a change in at least a first presentation file of the number of presentation files, and provide at least the first presentation file to the separate computing device, where the software application is configured to execute the first presentation file as at least one of (a) the functionality and (b) the user interface of the software application without need for re-installing or re-loading the software application on the separate computing device.

In some embodiments, obtaining the number of content files includes obtaining at least a portion of the number of content files, via a network, from a remote computing device. The instructions, when executed, may further cause the processor to, responsive to identifying the change in the first presentation file, cause replication of the first presentation file in a storage repository accessible to the remote computing device. Providing the first presentation file to the separate computing device may include causing the first presentation file to be accessible to the separate computing device via the network.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIGS. 1A through 1F are system diagrams illustrating a software development environment that may be used for creating software applications for computing devices;

FIGS. 2A through 2C are flow charts illustrating example methods that may be used for developing software applications for computing devices;

FIGS. 3A and 3B are flow charts illustrating additional example methods that may be used for developing software applications for computing devices;

FIGS. 4A and 4B are flow charts illustrating further example methods that may be used for developing software applications for computing devices;

FIGS. 5A through 5H illustrate example user interfaces for a software development environment that may be used for creating software applications for computing devices;

FIG. 6 is a block diagram of another example network environment for creating software applications for computing devices;

FIG. 7 is a block diagram of a computing device and a mobile computing device.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

In some implementations, the present disclosure may be directed to environments and methods for development of software for computing devices. The development process, in some implementations, may include cross-platform development of a software application for deployment on two or more computing device platforms. A computing device platform, in some examples, may refer to a particular set of configuration parameters such as one or more of a device operating system (e.g., Microsoft® Windows® by Microsoft Corporation of Redmond, Wash., Linux™, Apple® Mac™ OS by Apple Inc. of Cupertino, Calif., Research in Motion (RIM) Blackberry® OS by Research in Motion Limited of Waterloo, Ontario, etc.), an operating system version, a device application format (e.g., Apple® iOS™ by Apple Inc., Android™ by Google Inc. of Menlo Park, Calif., Windows® Phone by Microsoft Corporation, Palm™ webOS™ by Hewlett-Packard Company of Palo Alto, Calif., Symbian™ by Accenture PLC of Dublin, Ireland, Bada™ by Samsung Electronics of Seoul, S. Korea, etc.), and a device peripheral configuration (e.g., input and output devices such as, in some examples, sensors, speakers, microphones, virtual and/or miniaturized keyboard, buttons and other physical control inputs, etc.).

As described herein, an integrated cloud environment (ICE), in some implementations, may provide an interface for developing a cross-platform software application that may be compiled to run on two or more computing device platforms. In some implementations, an integrated cloud environment may include features for designing, constructing, compiling, testing, and/or distributing software applications for a number of wireless computing device platforms. In some implementations, the integrated cloud environment may additionally provide features for designing, constructing, compiling testing, and/or distributing software applications for web-based applications (e.g., browser based Web applications, applications compatible with Facebook® by Facebook, Inc. of Cambridge, Mass., server-side Web applications such as ASP.NET by Microsoft, etc.). The integrated cloud environment, in some implementations, may provide a developer with a development environment that is removed from individual software development kits (SDKs) or integrated development environments (IDEs) (e.g., xCode™ by Apple, Inc., Eclipse by the Eclipse Foundation of Ottawa, Canada, Visual Studio® by Microsoft, Rational Application developer for WebSphere® software by International Business Machines Corp. (IBM) of Armonk, N.Y., etc.) and/or programming languages (e.g., Objective-C, Java, C#, etc.) typically used for developing software applications for various platforms of wireless computing devices and Web applications. In some implementations, an integrated cloud environment for development of cross-platform software applications may involve an application developer interface installed on a local development computing device for developing and simulating a platform-independent version of the cross-platform software application. The integrated cloud environment for development of cross-platform software applications, in some implementations, may involve an application developer interface presented to a developer through an Internet browser program. The application developer interface may provide the developer with a communication channel to an integrated cloud environment for compiling the platform-independent development files with platform-specific files, for example using aspects of various software development kits or integrated development environments provided for application development towards specific computing device platforms.

In some implementations, cross-platform development for various computing devices may be enabled through an abstraction layer that allows the developer to define much of the behavior of an application through non-compiled resource files (e.g., “presentation files” as used herein), such as, in some examples, mark-up languages such as HyperText Markup Language (HTML), interpreted languages such as JavaScript, and style sheet languages such as Cascading Style Sheets (CSS). The presentation files, for example, may include commands for interacting with device peripherals, such as sensors, controls, and input/output mechanisms. In some implementations, the presentation files may further include commands for interacting with Web-based services such as device or platform-specific application programming interfaces (APIs). In some implementations, the abstraction layer for translating presentation files to platform-specific wireless computing device commands may be developed using the Apache Cordova platform by the Apache Software Foundation of Forest Hill, Md.

The presentation files, in some implementations, may be interpreted at run-time on the computing device to enable interactions between a user and the computing device. In some implementations, the presentation files may be interpreted by a browser engine feature of the computing device. In some implementations, the presentation files may be provided for presentation in a “windowless” (e.g., full screen, without defining browser border, etc) web-browser interface rendered upon the computing device. In some implementations, the presentation files may be combined with a number of media files, such as audio, image, and video files that may be accessed and presented during execution of the application through links to the media files incorporated in the presentation files. The combination of the media files and the presentation files, in some implementations, may be referred to as the “content files” of the cross-platform application project.

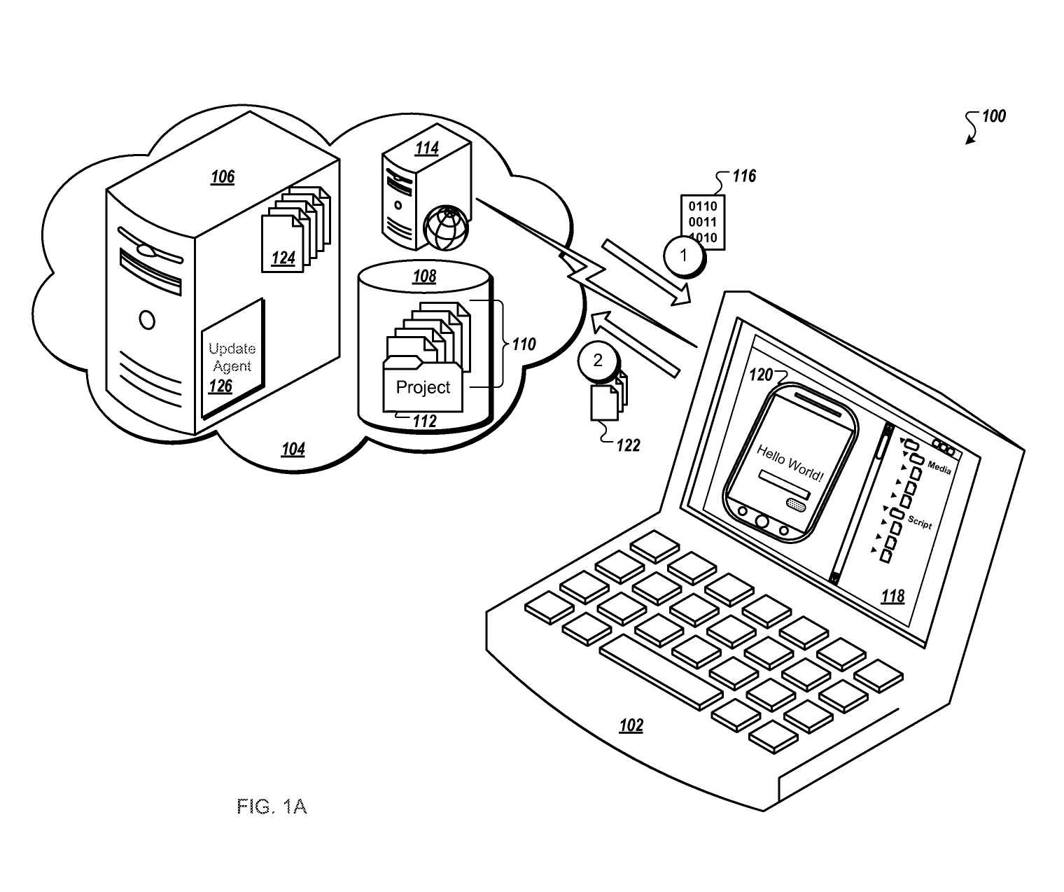

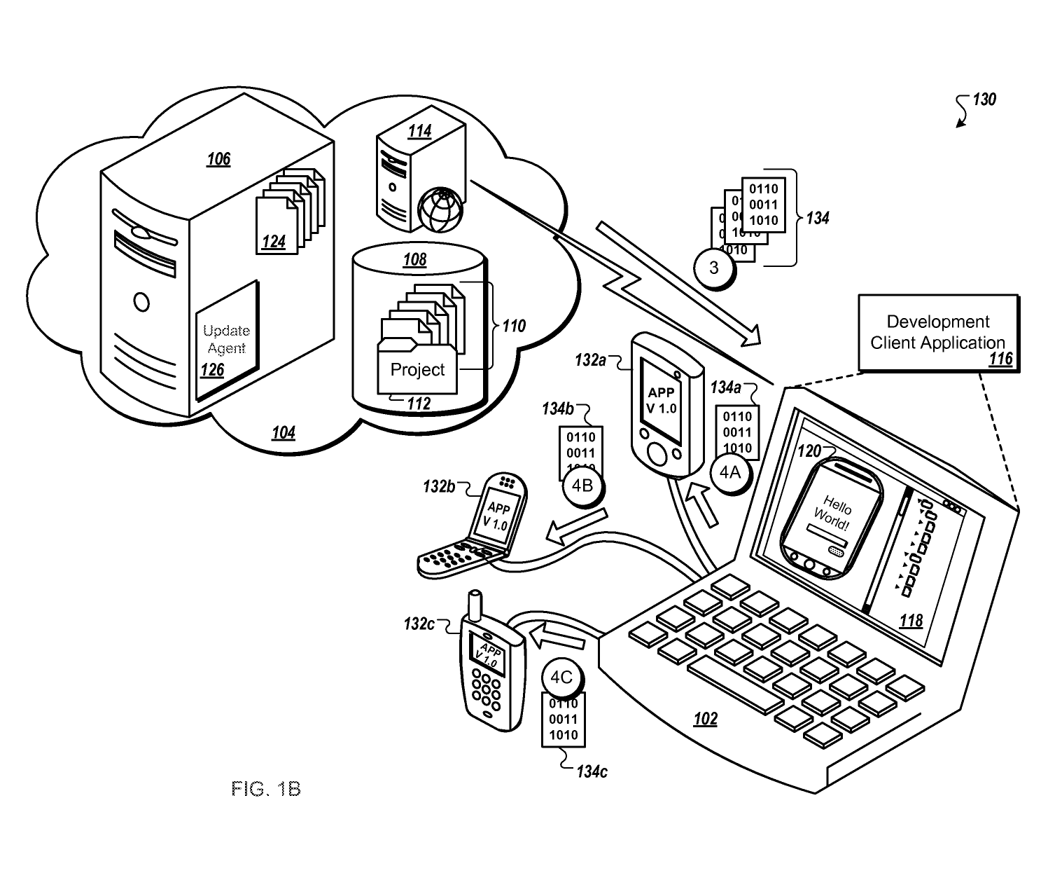

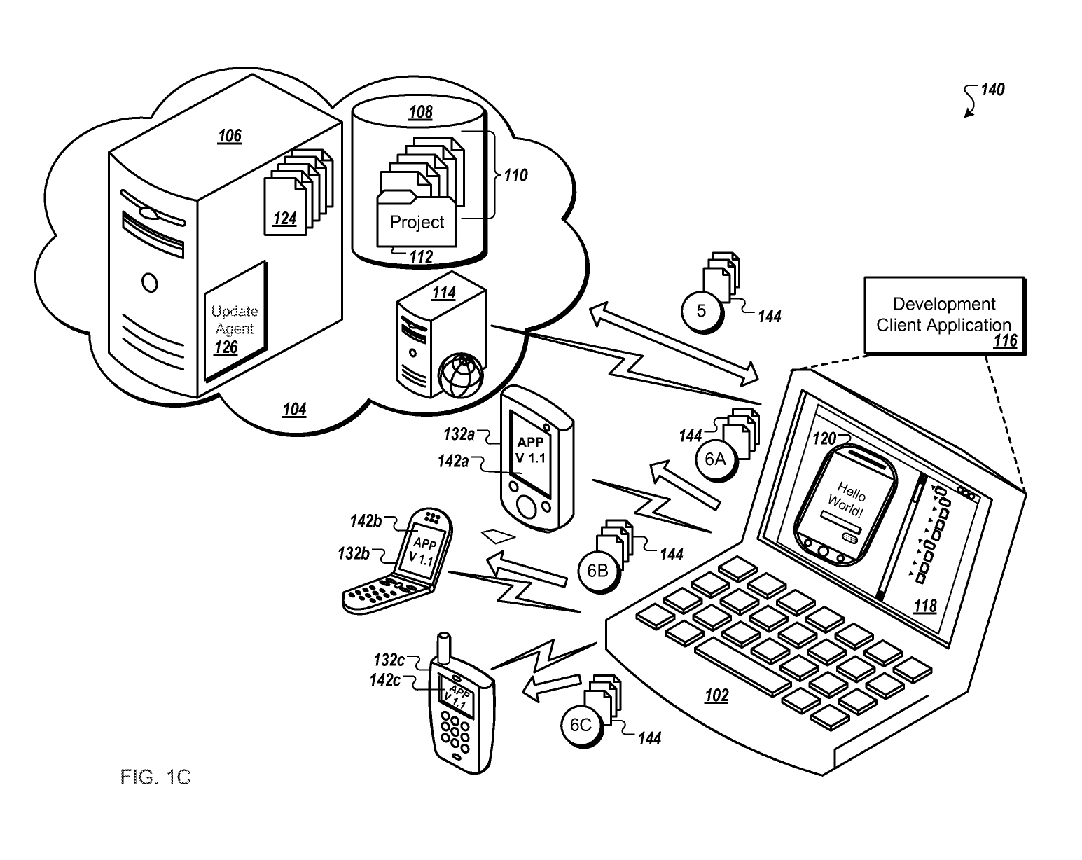

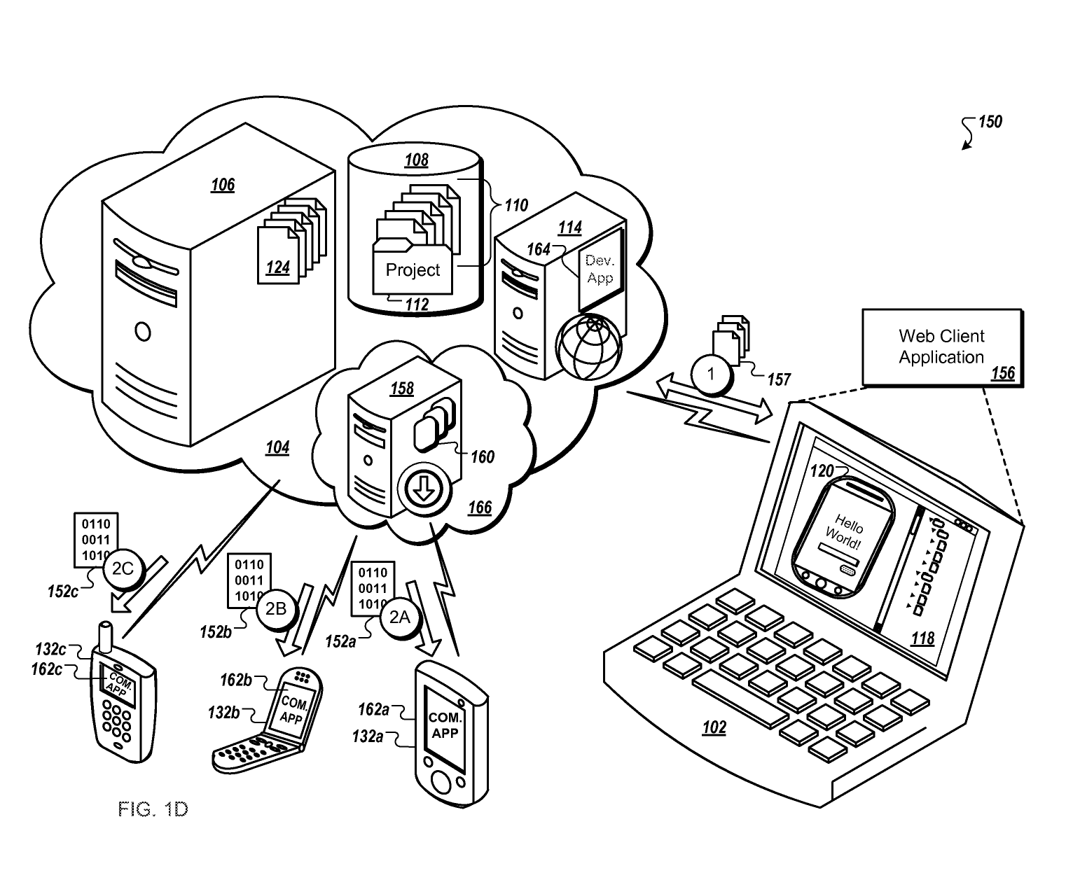

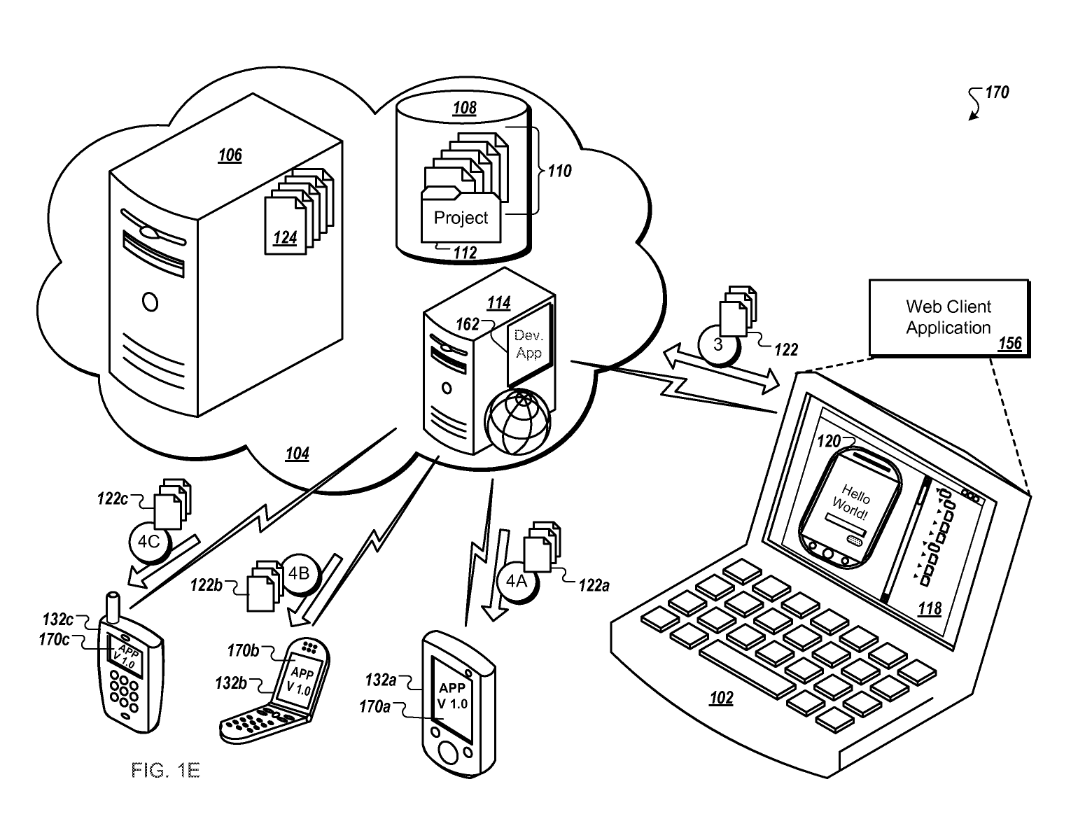

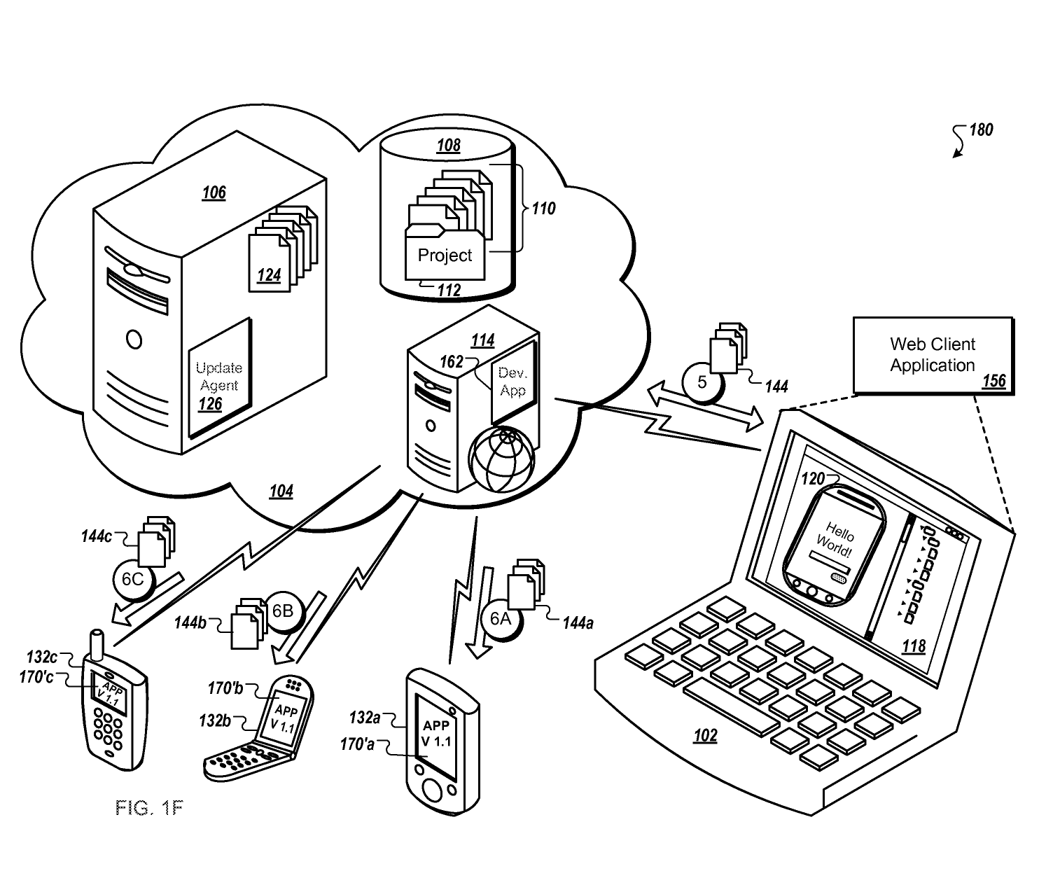

FIGS. 1A through 1F, in some implementations, may illustrate variations of an integrated cloud environment for developing cross-platform software applications for deployment to a number of computing devices including two or more device platforms. FIGS. 1A through 1C, for example, may illustrate an integrated cloud environment using a desktop client application for development of cross-platform software applications, while FIGS. 1D through 1F may illustrate an integrated cloud environment using a cloud-implemented (e.g., browser-based) application for development of cross-platform software applications.

Turning to FIG. 1A, the integrated cloud environment 100 may include a development computing device 102 (e.g., laptop computer, desktop computer, tablet computer, notebook computer or other computing device configurable for software development purposes) in communication with a cloud network 104. The cloud network 104, in some implementations, may include a development server 106 for generation of platform-specific computing device applications, a project repository 108 for storing project flies 110 (e.g., content files and other files) related to a cross-platform software application project as collected, for example, in a project directory 112, and a web server 114 for enabling a development environment interface between the development computing device 102 and the cloud network 104.

To begin development in the integrated cloud environment 100, in some implementations, a developer may first download and install a development client application 116 on the development computing device 102. The development client application 116, in some examples, may be downloaded from the network cloud 104 (e.g., as illustrated), downloaded through another network (e.g., via a Web browser or Web-based application store, etc.) or installed via a removable computer-readable medium accessible to the development computing device 102 such as, in some examples, a compact disk (CD), digital video disk (DVD), or Universal Serial Bus (USB) memory device.

In some implementations, the development client application 116 may enable local presentation of a development interface 118 on the development computing device 102. The development client application 116, in some implementations, may include features or include access to cloud-based features (e.g., provided via the web server 114) for programming and debugging a cross-platform software application using presentation files and other (e.g., media, metadata, etc.) files via the development interface 118.

In some implementations, the development client application 116 may further include features or include access to cloud-based features (e.g., provided via the web server 114) for simulating a software application upon two or more computing device platforms via the development interface 118. For example, a first device simulator with a first screen size and first peripheral and control features may be presented to simulate a first device platform (e.g., such as a device simulator 120 presented in the development interface 118), and a second device simulator with a second screen size and second peripheral and control features may be presented to simulate a second device platform.

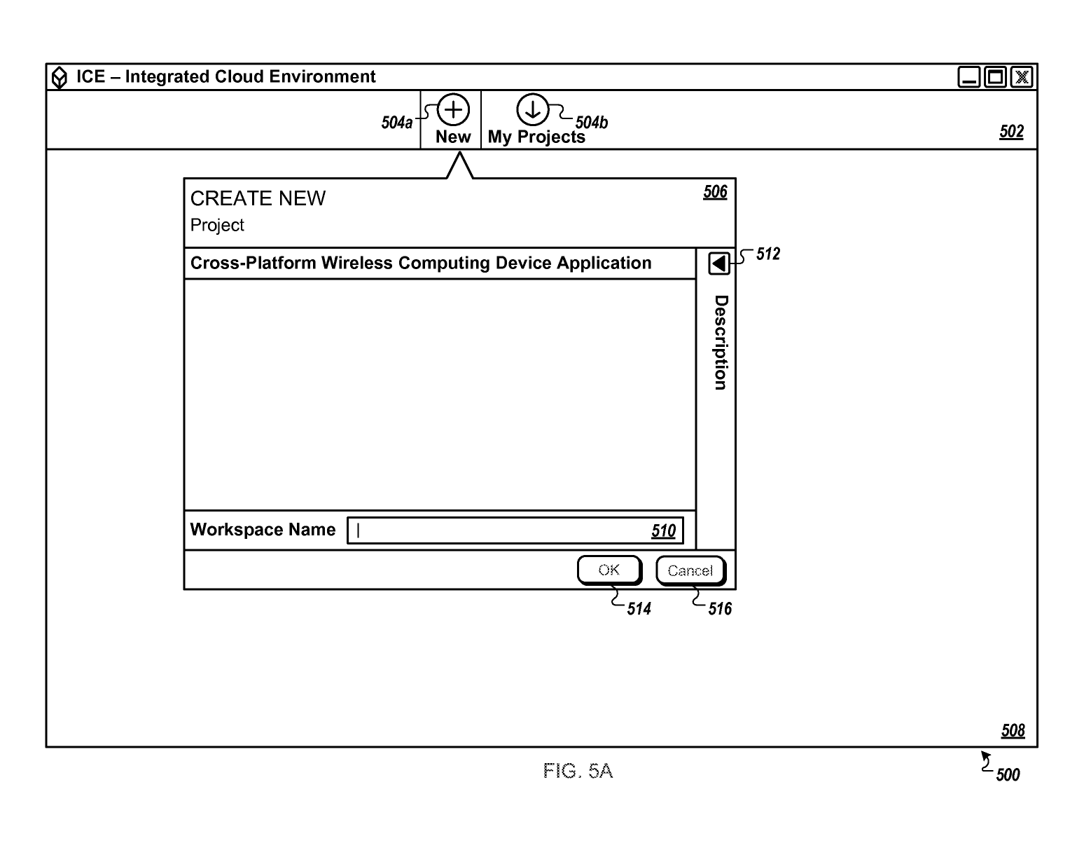

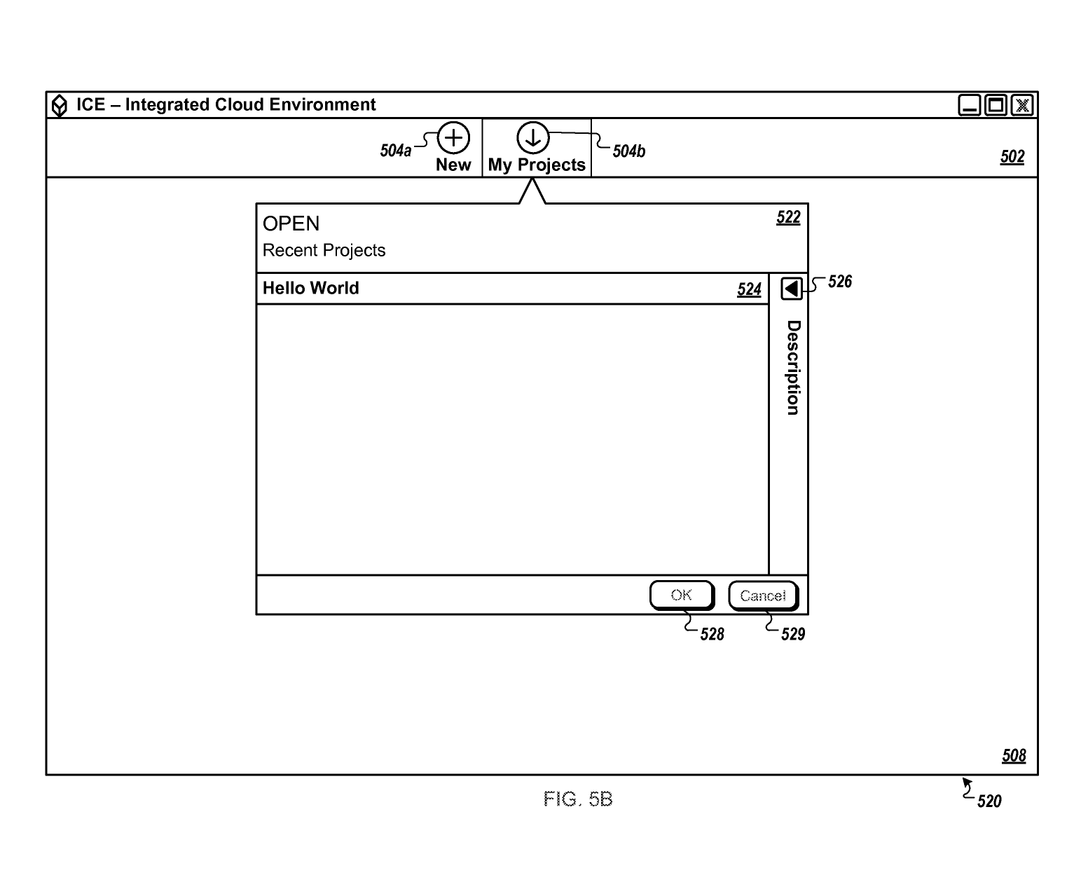

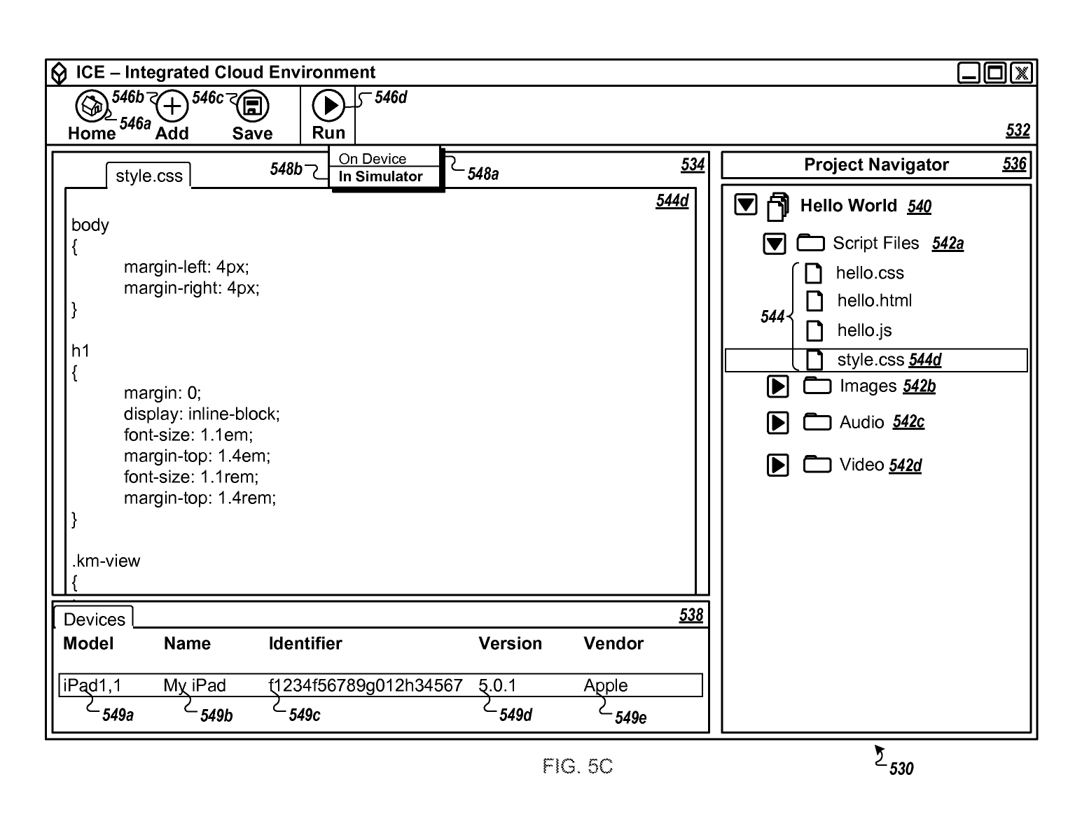

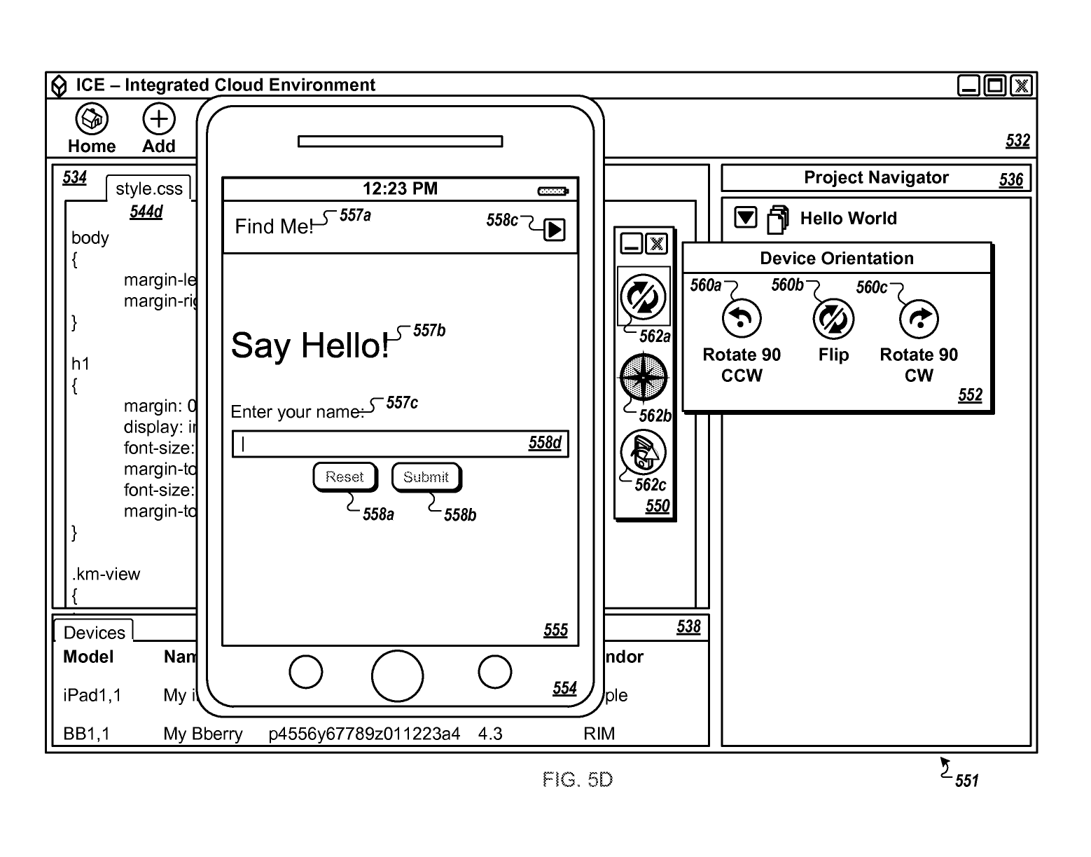

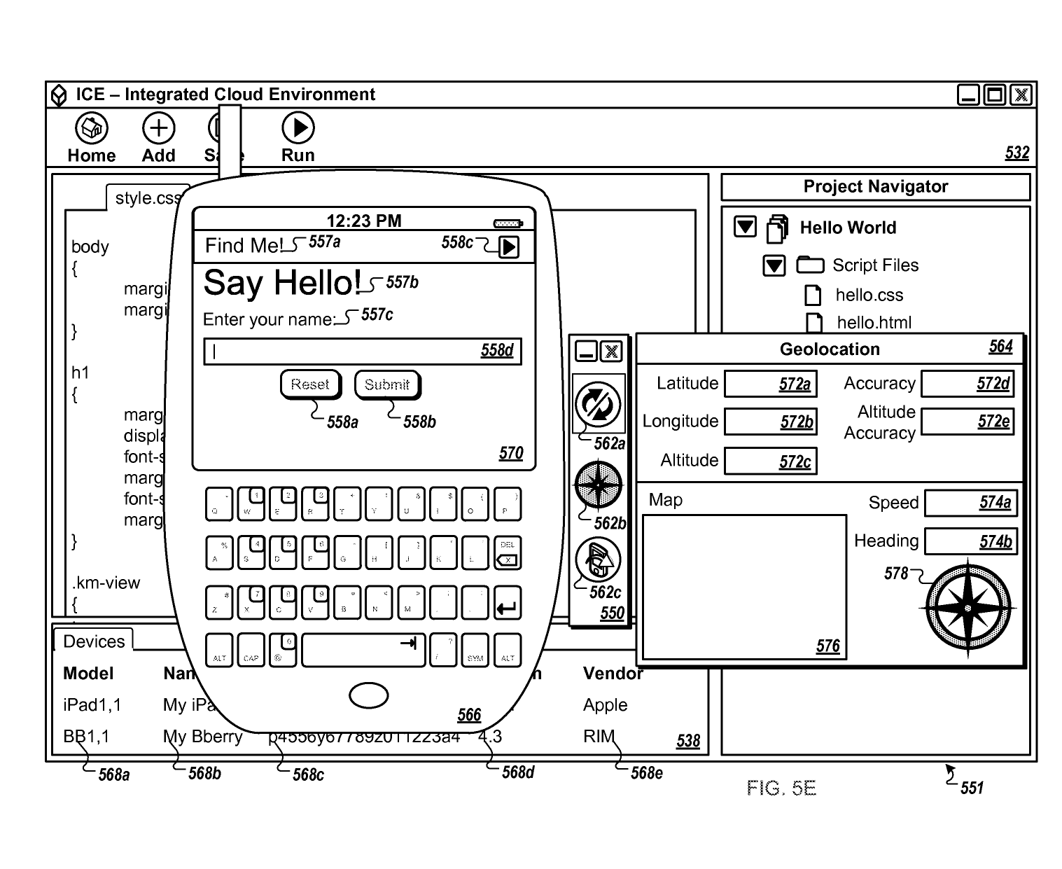

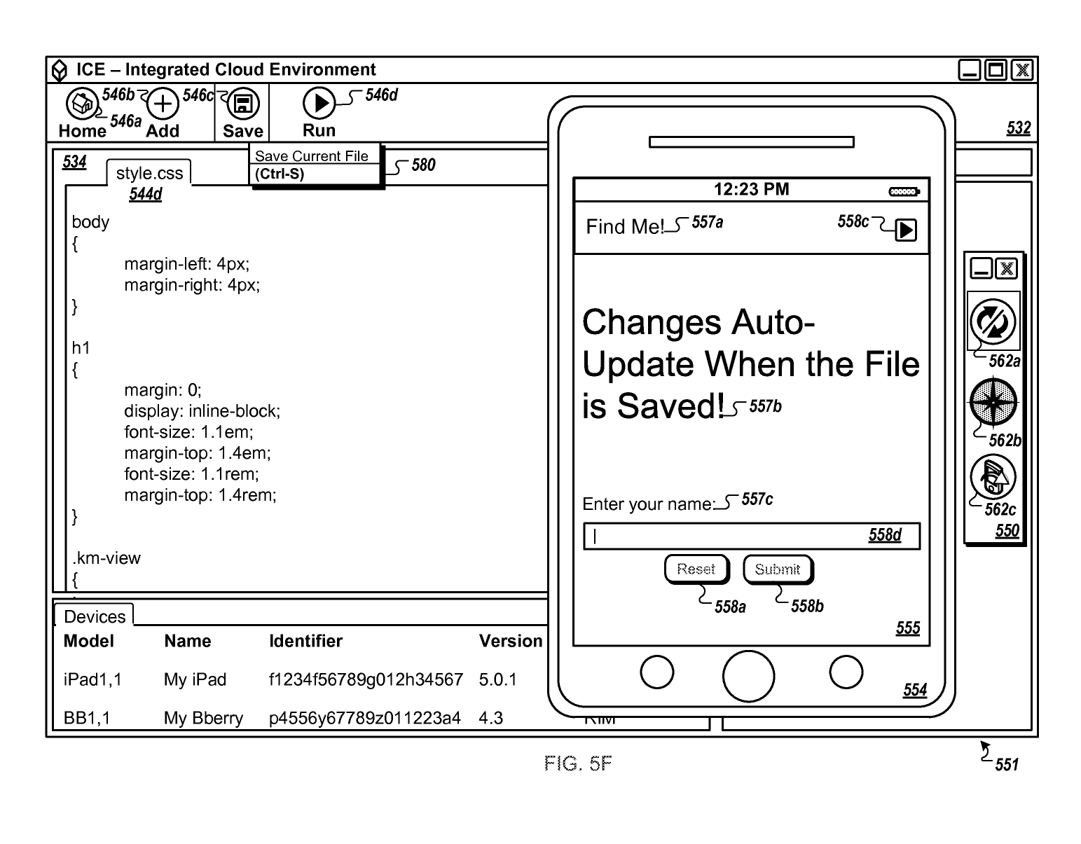

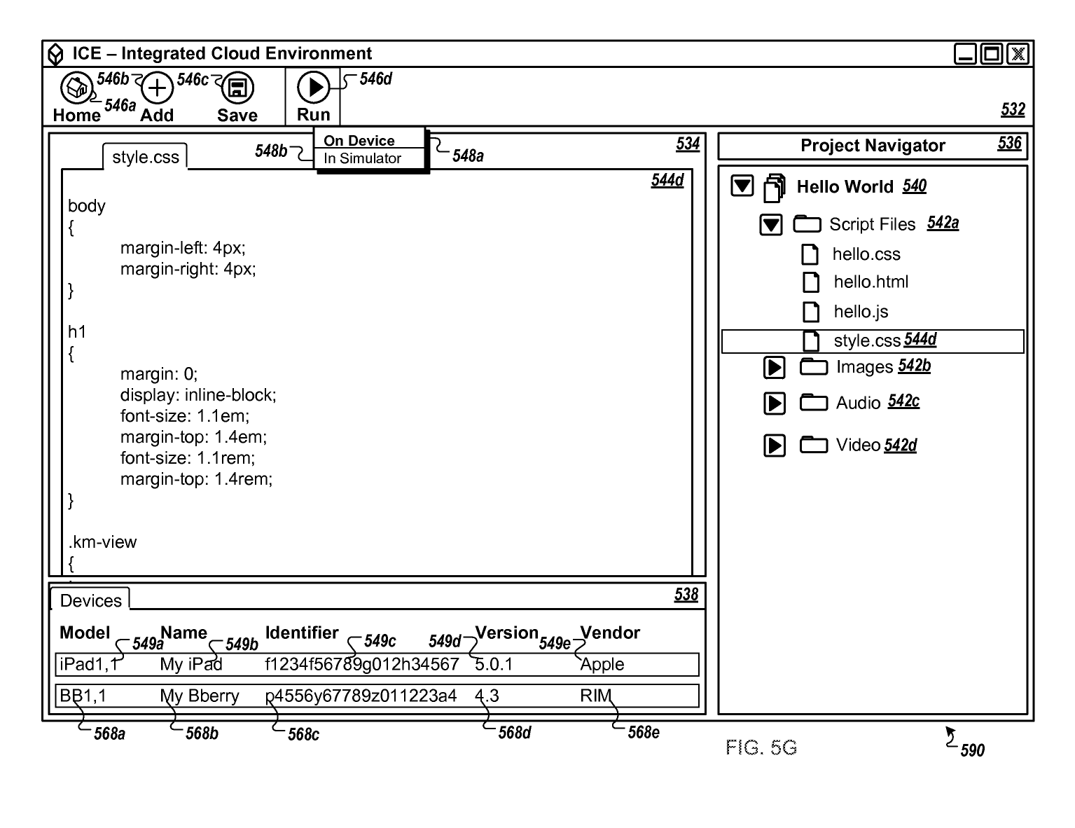

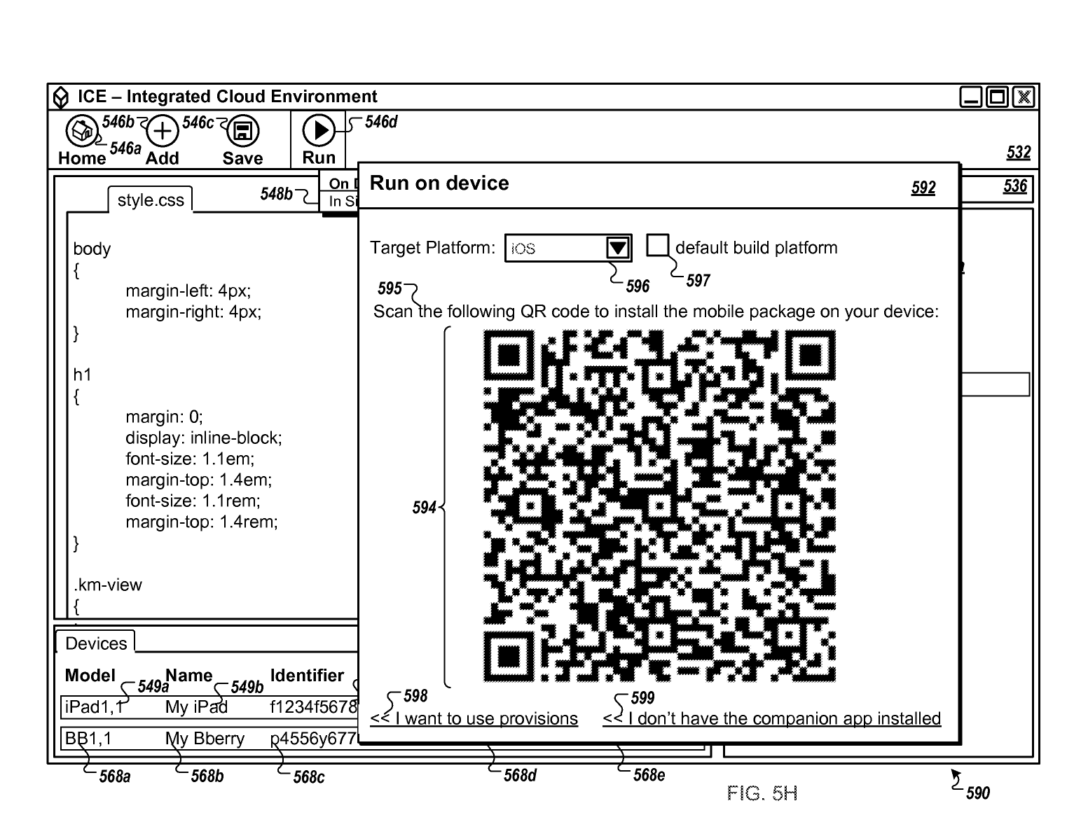

In some implementations, the device simulator 120 may include one or more sensor input/output simulation features for simulating behaviors of sensors, input/output elements, and other features on the simulated device platform. Such features, for example, will be discussed in detail in relation to the user interfaces illustrated in FIGS. 5A through 5H.

Once a developer is pleased with the performance of the simulated application, in some implementations, the developer may upload any locally-stored project files 122 (e.g., presentation files, media files, etc.) to the project repository 108 where they may be stored, for example, as a portion of the project files 110 in the project directory 112. In some implementations, the development client application 116 may replicate and/or maintain one or more of the project files 122 in the project repository 108 during development of the cross-platform software application. For example, upon saving a file, the development client application 116 may initiate upload of the new or modified file to the project repository 108. In some implementations, the project files 122 may remain local to the development computing device 102 until a time at which the developer requests the generation of one or more platform-specific application files (e.g., executable file, installation file, downloadable bundle of runtime files such as a zip file, etc.).

To enable generation of a platform-specific application file, in some implementations, the development client application 116 may replicate a portion of the locally-stored project files 122 to the project repository 108. From the project repository 108, for example, the project files 110 may be combined with platform-specific files 124 to create a platform-specific application file. In some implementations, an update agent 126 may be included in a platform-specific application file, for example to enable partial updates of the content files during testing upon a target computing device. In some implementations, a platform-specific application file may include a platform-specific or device-specific electronic signature, for example to allow a particular target computing device to recognize the platform-specific application file as a trusted file rather than malware or a potential virus. In some implementations, the development client application 116 may upload target wireless computing device information including, in some examples, a device brand, model, operating system, operating system version, or unique device identifier. The development client application 116, in some implementations, may upload developer information such as, in some implementations, demographic information regarding the developer (e.g., name, contact information, etc.) and a certificate of authentication as provided by a signing authority, such as a signing authority corresponding to a particular wireless device platform.

In some implementations, the development client application 116 may provide an indication from the developer as to whether to include the update agent 126 in the build of the platform-specific application file. For example, a developer may specify inclusion of the update agent 126 in the platform-specific application file(s) to allow each of the platform-specific application file(s) to be partially updated during execution of the application on a respective target computing device. In another example, a developer may have the option of generating a debugging-mode application file (e.g., including the update agent 126) or a production-mode application file (e.g., to be distributed to end users through an application store, Web-based download site, or other distribution mechanism).

Turning to FIG. 1B, an integrated cloud environment 130, in some implementations, may further include a set of target wireless computing devices 132 such as a smart phone 132a, a flip phone 132b, and a personal digital assistant (PDA) 132c. As illustrated, each of the target wireless computing devices 132 is individually tethered to the development computing device 102, for example by a cord or wire plugged into a port of the development computing device 102. In some implementations, rather than being connected to the development computing device 102 via a wired connection, one or more of the target wireless computing devices 132 may be accessible to the development computing device 102 through a wireless mechanism. For example, one or more of the target wireless computing devices 132 may be connected to a same local area network (LAN), campus network, Wi-Fi™ network, or other wireless networking connection as the development computing device 102. In some implementations, the choice of a direct or wireless connection between a particular target wireless computing device 132 and the development computing device 102 may be based, in part, upon permissions of a particular brand or platform of the target wireless computing device 132 in relation to the upload of new executable files for development purposes. For example, certain brands or platforms may not provide the opportunity for wireless download of a development-mode application file.

As illustrated, in some implementations, a set of platform-specific executable files 134 (e.g., installation files, application files, etc.) may be delivered to the development computing device 102 from the cloud network 104. In some implementations, the platform-specific executable files 134 may each be tailored to a particular target wireless computing device 132. The development client application 116, in some implementations, may identify each of the platform-specific executable files 134 as belonging to a particular one of the target wireless computing devices 132 and download the associated platform-specific executable file 134 to each respective target wireless computing device 132. For example, a first platform-specific development executable file 134a may be pushed to the smart phone 132a by the development client application 116, while a second platform-specific executable file 134b may be pushed to the flip phone 132b and a third platform-specific executable file 134c may be pushed to the PDA 132c. In some implementations, each of the platform-specific executable files 134 may automatically install upon the respective target wireless computing device 132 upon upload of the platform-specific executable files 134 from the development client application 116. In other implementations, a developer may initiate installation upon each target wireless computing device 132.

Turning to FIG. 1C, an updated development client application 140, in some implementations, may further include wireless communication between each of the target wireless computing devices 132 and the development computing device 102. For example, each of the target wireless computing devices 132 may be connected to a same wireless network as the development computing device 102, while not necessarily being connected to the same wireless network between each of the target wireless computing devices 132. For example, the flip phone 132b may be connected to a Wi-Fi™ network, while the PDA 132c may be connected to a Bluetooth® network. In some implementations, the update agent 126 may include a unique wireless identifier to enable the development client application 116 to recognize each of the target wireless computing devices 132 on a given network. In some implementations, the update agent 126 may include a unique identifier to enable the development client application 116 to recognize a particular platform-specific development application 142 (e.g., installed using a particular platform-specific executable file 134 as described in relation to FIG. 1B) running on each respective target wireless computing device 132.

While testing the platform-specific development applications 142 on each of the target wireless computing devices 132, in some implementations, a developer may choose to modify one or more of the content files 144 (e.g., through the development interface 118 on the development computing device 102). The content files 144, for example, may include one or more presentation files or media files that are accessed during run time by a presentation file. In some implementations, changes to the content files 144 may be provided to the cloud network 104, for example upon saving each modified content file 144 or upon requesting that the platform-specific applications 142 be updated with the modified content files 144. The modifications made to the content files 144, in some implementations, may be added to the project files 110 in the project repository 108. In some implementations, updated content files 144 may replace existing project files 110 stored in the project repository 108. One or more of the updated content files 144, in some implementations, may be added to the project directory 112 as a new version of an existing project file 110.

If the modified content files 144 are interpreted during run time, rather than being compiled into a binary executable, in some implementations, the modified content files 144 may be pushed to one or more of the target wireless computing devices 132 for use by the respective platform-specific development application 142. In some implementations, the development client application 116 may open a file transfer connection with each of the target wireless computing devices 132. For example, the update agent 126 running via each of the platform-specific development applications 142 may, in some implementations, enable creation of a file-sharing session with the development client application 116. Although illustrated as a transfer across a wireless connection, in some implementations, one or more of the target wireless computing devices 132 may be tethered to the development computing device 102. Additionally, although each of the target wireless computing devices 132 is illustrated as receiving copies of the content files 144, in some implementations, the developer may select a portion of the target wireless computing devices 132 for receipt of the content files 144. For example, the developer may verify functionality on the smart phone 132a without providing the updated content files 144 to the flip phone 132b and the PDA 132c.

The update agent 126 running via each of the platform-specific development applications 142, in some implementations, may monitor a content file directory on the respective target wireless computing device 132 to recognize the addition or updating of content files. In some implementations, upon recognition of a new or updated content file, the update agent 126 may refresh the current presentation of the platform-specific development application 142. In this manner, for example, the modification made by the developer may be immediately reflected in the user interface on each updated target wireless computing device 132 without need for reloading or restarting the respective platform-specific development application 142.

In a similar integrated cloud environment 150, in some implementations, a developer may develop and test a cross-platform software application by connecting to the web server 114 in the cloud network 104 to work within a web client application 156. The web client application 156, in some implementations, may be a browser-based program for delivering a server-side development client application 164. For example, Web client application presentation files 151 may be provided (e.g., downloaded) to the development computing device 102 to enable development via the development interface 118. In some implementations, the web client application 156 may be a desk top or mobile device application capable of integrating with the development client application 164 provided by the web server 114. As with the integrated cloud environment 100 described in relation to FIG. 1A, the web client application 156 and/or the development client application 164, in some implementations, may be used to present the development interface 118 including the device simulator 120.

While developing a cross-platform software application, a developer may create one or more content files and/or upload one or more content files to the web server 114. The content files, in some implementations, may be stored within the project files 110 of the project directory 112, for example within the project repository 108.

In some implementations, a developer may download a companion application installation executable 152 to one or more of the target wireless computing devices 132. The companion application installation executable 152, in some implementations, may be available through a mobile device application server 158, for example via an application store 160 including a number of mobile device applications provided for purchase or for free. In some implementations, two or more mobile device application servers may provide access to the companion application installation executable 152. For example, the application store 160 may be a platform-specific app store, such as the Apple® App Store for iPhone™, by Apple Inc. In some implementations, the mobile device application server 158 may be provided within a separate network 166 from the cloud network 104. In other implementations, the network 166 may be included within the cloud network 104. Each of the companion application executables 152a, 152b, and 152c may be generated to operate with a particular operating system and/or device platform. For example, the companion application executable 152a may be generated for installation upon the device platform of the target wireless computing device 132a.

Upon download of the companion application installation executables 152, a respective companion application 162a, 162b, 162c may be installed upon the respective target wireless computing device 132a, 132b, 132c. The companion applications 162, in some implementations, may be used to generate a shell environment for presenting the content files 144 developed via the development client application 164 and web client application 156. In some implementations, the companion applications 162 may include a windowless browser feature for presenting the content files 144. The companion applications 162, in some implementations, may include additional functionality, such as a receiving agent (not illustrated) capable of receiving content files from the cloud network 104 and an update agent (not illustrated) configured to allow content files to be updated within the companion applications 162, for example upon request and/or automatically.

Turning to FIG. 1E, after having installed the companion applications 162, content files 122 related to a current project (e.g., as developed via the development client application 164 and the web client application 156, accumulated in the project directory 112) may be downloaded and rendered within the companion applications 162. For example, the companion applications 162 may behave as a shell for launching the functionality of the cross-platform software application developed within the development client application 164 and web client application 156. This functionality, for example a development application 170a, 170b, 170c, may be launched within the companion applications 162. In some implementations, the companion applications 162 may organize two or more development applications (e.g., corresponding to two or more cross-platform software application projects), or two or more versions of a single development application for ongoing testing and development of cross-platform software applications.

As illustrated in FIG. 1F, one or more content files 144 may be modified, updated, or added after the cross-platform development application has been deployed to the target wireless computing devices 132. In some implementations, the content files 144 may be pulled to the target wireless computing devices 132. For example, upon a menu selection, preset touch screen gesture, or access to a network location, each of the target wireless computing devices 132 may receive one or more content files 144. Download of the content files 144, in some implementations, may be aided by functionality built into the companion application 162. In some implementations, the content files 144 may be automatically pushed to one or more of the target wireless computing devices 132. For example, through a network connection with the cloud network 104 or via a wireless connection with the computing device 102, the content files 144 may be delivered to one or more of the target wireless computing devices 132.

In some implementations, upon download of the content files 144, the companion application 162 may regenerate the present display to automatically retrieve new content provided within the content files 144. For example, a functionality similar to the update agent 126, described in relation to FIGS. 1A through 1C, may be built into the companion application 162. In this manner, the companion applications 162a, 162b, and 162c may respectively present updated development applications 170′a, 170′b, and 170′c.

Once the developer has determined that the test application is functioning as desired, in some implementations, the project files 110 may be merged with platform specific files 124, for example within the development server 106, to build a deployment application. The deployment application, in some implementations, may be provided to the computing device 102 or transferred to an application store such as the application store 158 described in relation to FIG. 1D.

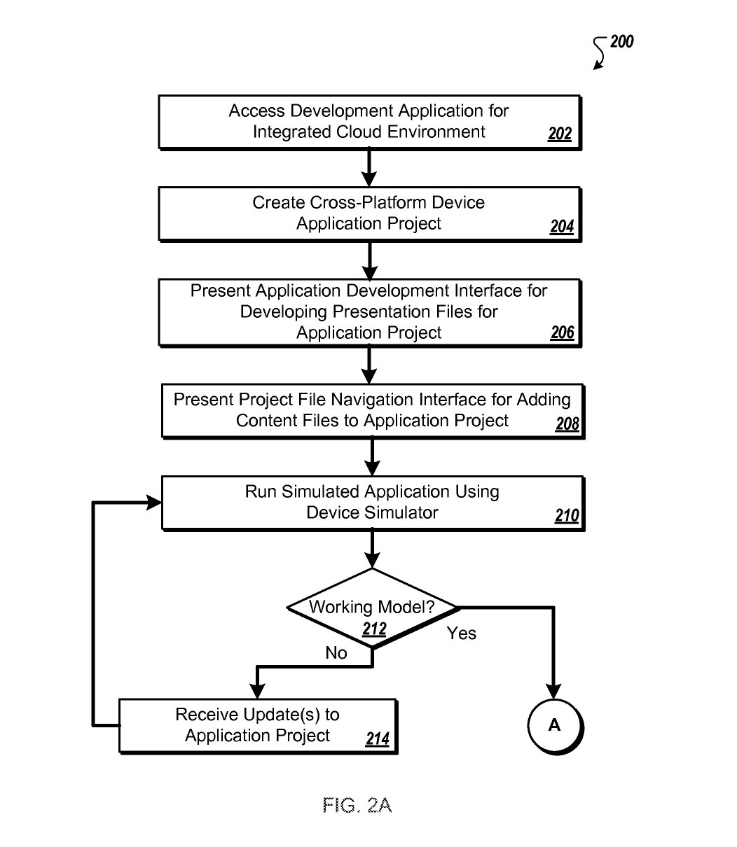

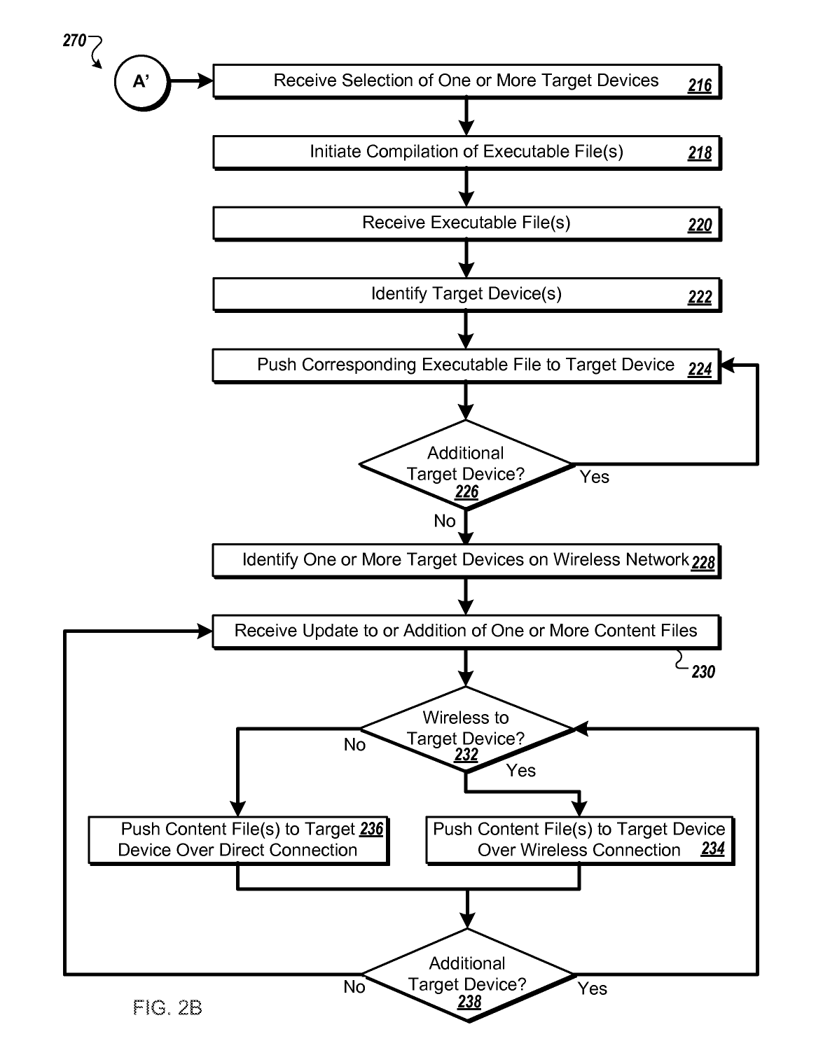

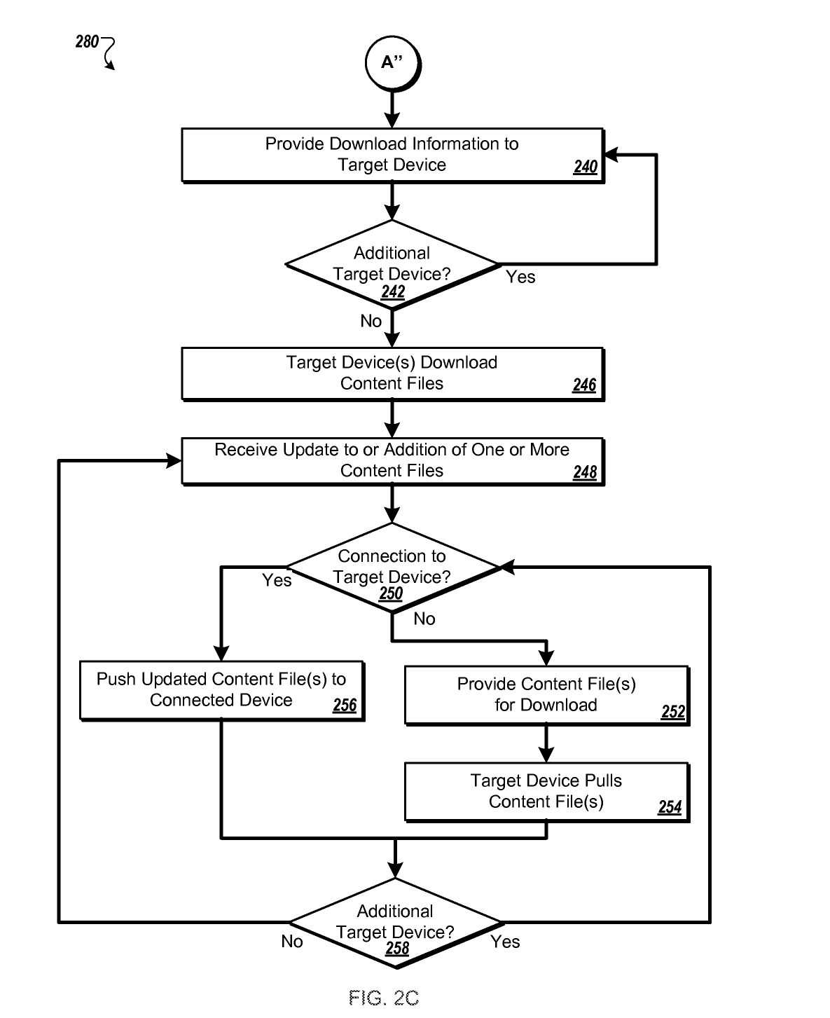

FIGS. 2A through 2C present flow charts illustrating a set of methods 200, 270, 280 for developing a cross-platform software application. The method 200, for example, may be combined with either the method 270 (e.g., in circumstances involving a client-installed development solution) or the method 280 (e.g., in circumstances involving a browser-based development environment).

Turning to FIG. 2A, in some implementations, the method 200 may begin with accessing a development client application for developing cross-platform software applications (202). In some implementations, accessing the development client application may include installing a client application for interfacing with an integrated cloud development environment. The development client application, in some implementations, may be provided through a light client or browser interface.

In some implementations, a cross-platform software application project may be created (204). The project, in some implementations, may be associated with one or more development files, target computing devices, and other resources for developing a cross-platform software application. Upon creation of a new project, in some implementations, one or more basic presentation files may be added to a project directory (e.g., local and/or accessible via a network cloud). The basic presentation files, for example, may be configured with standard inclusions and structure to provide a rough framework for presentation of an application interface. In some implementations, the basic presentation files may include at least one mark-up language file describing the presentation of the application including, in some examples, text, controls, and images. Furthermore, in some implementation, the basic presentation files may include one or more style sheet files for describing styles that may be applied to the presentation at run-time plus one or more interpretation language files that may support programmatic actions to be performed such as, in some examples, responses to user-initiated actions (e.g., control selections, text input, voice input, etc.) and responses to device events (e.g., response to a device sensor event). In a particular example, the basic presentation files may include a JavaScript file for interfacing with a windowless browser presentation engine, a style.css file for establishing basic display settings, and an index.html file for linking the various presentation files together.

In some implementations, an abstraction layer library may be included to enable calls to features, input/output elements, sensors, and/or peripheral devices included in a particular wireless computing device platform. For example, Apache Cordova may be included to provide access to features of a wireless computing device platform. Generic functions available using the abstraction layer, for example, may be mapped to specific sensor devices, input/output devices, or other features of individual computing device platforms (e.g., through an application programming interface), allowing a developer to interact with these features without knowing specific information regarding the feature as implemented on a per-platform level. In some examples, the abstraction layer may include generic calls to a speaker element, accelerometer element, global position system (GPS) element, or other element common to many computing devices.

In some implementations, a developer may register a new user account with the integrated cloud environment or log into an existing account with the integrated cloud environment prior to creating a new project. During project creation, one or more project directories may be created for storing project materials (e.g., metadata, presentation files, media files, executable files, etc.) used in the development of the cross-platform software application.

In some implementations, an application development user interlace may be presented for developing presentation files for the cross-platform software application project (206). The presentation files, in some implementations, may form a portion of a set of platform-independent content files to be interpreted at run time as the user interface of the cross-platform software application. The application development user interface, in some implementations, may include an editor for editing presentation files (e.g., HTML, CSS, and JavaScript files, etc.). The editor, in some implementations, may include syntax coloring, syntax formatting, refactoring, and/or code navigation capabilities to enable the developer to easily create and modify a set of interrelated content files for the cross-platform software application project.

In some implementations, a project file navigation interface may be presented for adding content files to the cross-platform software application project (208). In some implementations, the project file navigation interface may include several files and directories containing native platform code files related to one or more computing device platforms as well as files and directories of platform-independent content such as presentation files and media files. In some implementations, native platform code files may be managed in the network cloud, while platform-independent files may be replicated locally on a development computing device. In some implementations, the developer may copy files from other project directories into the current project directory to use in developing the new cross-platform software application. For example, the developer may have already created one or more cross-platform software applications in the integrated cloud environment. The developer, in some implementations, may drag and drop one or more locally stored media files, such as audio, image, and video files, into the project file navigation interface.

In some implementations, a simulation of the cross-platform software application may be run in a device simulator (210). For example, after creating, editing, and resolving any pre-compiler errors in the project content, such as linking issues in the content files, the developer may choose to build a simulator version of the cross-platform software application for testing in the development client application. The device simulator, in some implementations, may be rendered as an overlay in the development client application. In some implementations, the device simulator may launch as a separate application on the display region (e.g., built-in or external monitor, etc.) of the development computing device. The device simulator, in some implementations, may be configured to simulate a number of different computing device platforms. In some examples, the device simulator may include simulation structures for a variety of brands and models of smart phones, PDAs, tablet computers, portable multimedia devices, and other computing devices or device platforms. In some implementations, the simulator may include a control for changing the simulation structure to simulate a different type, brand, and/or model of device or device platform.

In some implementations, the developer may interact with the simulation through controls illustrated on the simulation structure. For example, the developer may select (e.g., via a gesture on a touch screen, click with a mouse or other pointing device, etc.) buttons or other controls, such as the keys of a built-in keyboard, rendered in the simulation structure. In some implementations, the developer may use an input device connected to the development computing device, such as a keyboard and/or mouse, to provide input (e.g., login information, “touches” to touch screen based controls, etc.) to the simulated application rendered by the device simulator.

In some implementations, the developer may feed a file of input “commands” to the device simulator. For example, a testing presentation file may contain a number of input commands for simulating input to the simulation of the cross-platform software application, such as, in some examples, geolocation position information and accelerometer readings.

In some implementations, the device simulator may include features for simulating user input such as sensor data and device orientation. For example, the device simulator may include an input mechanism to provide geolocation information, acceleration information, photosensor input, microphone input, or other simulated input.

During the simulation, based upon the functionality of the simulated application (212), in some implementations, updates to the cross-platform software application project may be received (214). For example, the developer may switch between interacting with the device simulator and updating one or more content files to adjust the behavior of the simulated application. In some implementations, updates to one or more content files that may be interpreted during run time may be applied to the simulated application while the simulated application is being executed by the device simulator. In some implementations, the display of the device simulator may be refreshed in response to the updated content file(s) to present to the developer the look of the simulated application including a change provided by the developer. In some examples, the change made within the updated content file(s) may effect the size, position, color or font style of rendered text, add or remove an interactive control, add a background image to the screen, or modify the behavior of the simulated application in response to interaction with the simulated device structure or other simulated input.

At some point, the developer may decide to nm the cross-platform software application on a target computing device. Turning to FIG. 2B, in some implementations, such as implementations involving a local development client application, the method 200 may be followed by the method 270, beginning with receiving selection of one or more target computing devices (216). In some implementations, a developer may select one or more target computing devices from a list of available brands and/or models of target computing devices. In some implementations, a target computing device platform may be supplied by the developer rather than an indication of a particular brand or model of computing device.

In some implementations, a developer may register one or more computing devices with a project or with the integrated cloud environment (e.g., through a user account). In some implementations, one or more of the computing devices may be registered as development devices with a wireless computing platform (e.g., Apple® iOS™, Google Android™, etc.). For example, a device may be provisioned as a “development device” to enable direct loading of development applications by a developer during the development process. Provisioning of a development device, for example, may be at the discretion of a particular computing device platform. In some implementations, a provision or certificate may be uploaded by the developer to authenticate the device with the integrated cloud environment. The supplied provision or certificate, in some implementations, may be associated with a user account, such that the computing device may be used in relation to any project associated with the developer.

Information regarding this registration, in some implementations, may be provided as metadata to the integrated cloud environment to be associated with the project. The developer, in some implementations, may select one or more target computing devices from a list of registered target computing devices.

In other implementations, the development client application may identify one or more computing devices in communication with the development computing device. For example, the development client application may retrieve information (e.g., identifier, platform information, etc.) for each computing device in communication with the development computing device and present these to the user as candidates for selection as target computing devices. In some implementations, upon detection of a computing device, the integrated cloud environment may determine whether the platform of the computing device requires provisioning as a development device. If so, in some implementations, the integrated cloud environment may prompt the developer to supply proof of provisioning of the computing device as a development device for the associated platform.

In some implementations, compilation of development application executable files may be initiated (218). The developer, in some implementations, may select, through a user interface of the development client application, a control (e.g., “Run on Target computing device”, “Compile Test Application for Target computing device”, etc.) that initiates generation of application executable files for installing the cross-platform software application upon select target computing devices. Responsive to selection of this control, for example, the development client application may initiate compilation of a platform-specific application executable file (e.g., an executable application file, installation file, etc.) for each target computing device selected. In some implementations, one or more content files may be uploaded to the integrated cloud environment for inclusion in the compilation of the development application executable files.

In some implementations, one or more development application executable files may be received (220). For example, the development computing device may receive one or more development application executable files from the cloud network. In some implementations, the development application executable files may include platform-specific functions and framework to install on and interface with the target computing device. The development application executable files, in some implementations, may include digital signatures used for verification or authorization via the target computing device platform. The development application executable files, in some implementations, may include an update agent for partial updating of the development application after installation upon the target computing device.

In some implementations, one or more target computing devices may be identified (222). For example, if not done in relation to selection of the one or more target computing devices, the development client application may identify one or more target computing devices in communication with the development computing device. In some implementations, the target computing devices may be in direct (e.g., tethered, wired) communication with the development computing device. In some implementations, one or more of the target computing devices may be in wireless communication with the development computing device.

For each identified target computing device (226), in some implementations, a corresponding application executable file may be pushed to the target computing device (224). In some implementations, the development client application may push each executable file to the respective target computing device. The developer, in some implementations, may manually transfer an application executable file to a corresponding target computing device. In some implementations, the application executable file may be configured to automatically install upon download to the target computing device. The development client application, in some implementations, may initiate execution of installation of the downloaded application executable file on one or more of the target computing devices. In some implementations, the application executable file may begin installing upon download. A developer, in some implementations, may initiate manual installation of an application executable file upon a target computing device.

In some implementations, one or more target computing devices may be identified on a wireless network (228). For example, at some point after the download and installation of the development computing device application on each target computing device, the developer may disconnect at least one of the target computing devices previously in direct connection to the development computing device. Further to the example, the target computing device may be in communication with a same wireless network (e.g., Wi-Fi™ Bluetooth®, etc.) as the development computing device.

In some implementations, updates to or addition of one or more content files may be received (230). For example, via the development client application user interface, the developer may apply modifications to one or more of the content files in response to observed behaviors during interaction with the development application running on one or more of the target computing devices. For example, a portion of the display may not be rendering as anticipated, or a control may not be responding in an anticipated manner. The developer, in some implementations, may apply a fix to the behavior through modification of one or more of the content files and/or addition of one or more new content files. If the modified and/or new content file(s) include only files that are interpreted during runtime, in some implementations, the update agent included in the development computing device application may be configured to receive and integrate the updated content files with the development computing device application.

For each target computing device (238), if a wireless connection with the target computing device is available (232), in some implementations, the updated and/or added content file(s) may be pushed to the target computing device over the wireless connection (234). In some implementations, the update agent built into the development application may be configured to establish a file sharing connection with the development computing device over a wireless network. In other implementations, a file sharing connection may be configured between the target computing device and the development computing device without the aid of an update agent. For example, wireless computing device platform communication protocols may be used to establish a connection between a wireless target computing device and the development computing device. If no wireless connection with the target computing device is available (232), in some implementations, the updated and/or added content file(s) may be pushed to the target computing device over the direct (e.g., wired, tethered) connection (236). In either the wired or wireless circumstance, in some implementations, the development client application may push the content file(s) into a directory structure on each target computing device that currently contains the content files used by the development application. In some implementations, the update agent compiled into the development application may retrieve one or more files pushed into a temporary directory and move the files into an active directory (e.g., a directory read from by the development application).

Turning to FIG. 2C, the method 200 may continue with the method 280, beginning with providing download information to a target computing device (240). For example, upon preparation of the content files of a project, a reference may be provided for a developer to point a target computing device to a network location to download the content files. In some implementations, a Quick Response (QR) code may be provided within a display area of the development computing device. A scanning feature of a target wireless computing device, for example, may be used to scan the QR code to retrieve a network location, such as a Universal Resource Locator (URL), where the content files may be obtained. In some implementations, a location may be provided to the display region of the development computing device, for example as text or as a hyperlink. For any additional devices (242), in some implementations, download information may be provided in a similar manner.

In some implementations, the target computing device(s) may download the content files using the download information (246). In some implementations, the content files may be downloaded into a companion application that behaves as a shell for demonstrating the functionality of the development application. The developer may proceed to test the development application upon the target computing device(s).

At some later point in time, in some implementations, an addition of one or more content files or updates to one or more content files may be received (248). For example, via the development client application user interface, the developer may apply modifications to one or more of the content files in response to observed behaviors during interaction with the development application running on one or more of the target computing devices. For example, a portion of the display may not be rendering as anticipated, or a control may not be responding in an anticipated manner. The developer, in some implementations, may apply a fix to the behavior through modification of one or more of the content files and/or addition of one or more new content files. In some implementations, the companion application may be configured to receive and integrate the updated and/or additional content files.

If there is a connection established with a particular target computing device (250), in some implementations, the content files may be pushed to the target computing device (256). For example, upon initial download of the content files, in some implementations, a shared network connection may be established between the integrated cloud environment and the target computing device. In other implementations, one or more content files may be pushed to a target computing device directly from the development computing device (e.g., after downloading the content files from the cloud network to the development computing device).

In some implementations, the content files may be provided for download (252). For example, the content files may be provided for download at the same network location as the initial set of content files or at a different network location.

In some implementations, the target computing device may pull the updated content file(s) (254). In some implementations, a developer may initiate download using a QR code, URL, or other input information. In other implementations, the network location may be stored within the target computing device (e.g., by a feature of the companion application), and the content files may be automatically pulled upon receiving a particular input from the developer. For example, upon selection of a menu item within the display or upon a particular gesture identified via a touch screen of the target computing device, the content files may be pulled to the target computing device. For each additional target computing device (258), depending upon whether there is a connection to the target computing device (250) for automatic push of content files (256) or the content files are pulled (254) to the target computing device, content files may be transferred to the target computing devices.

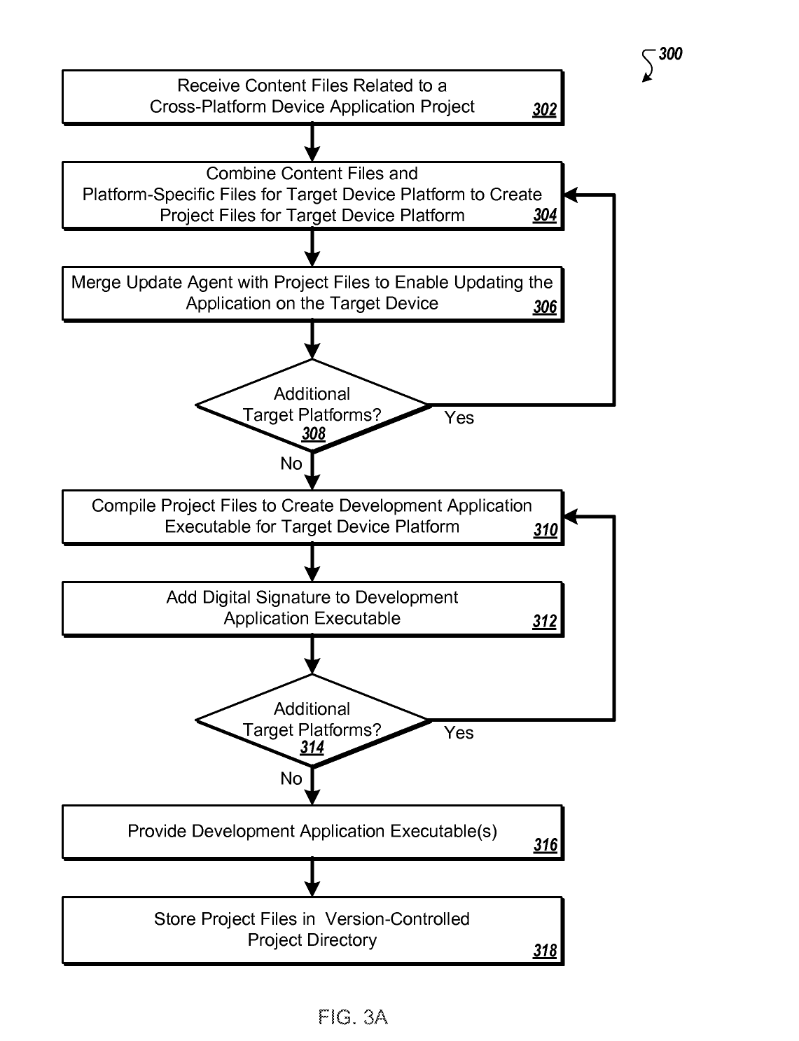

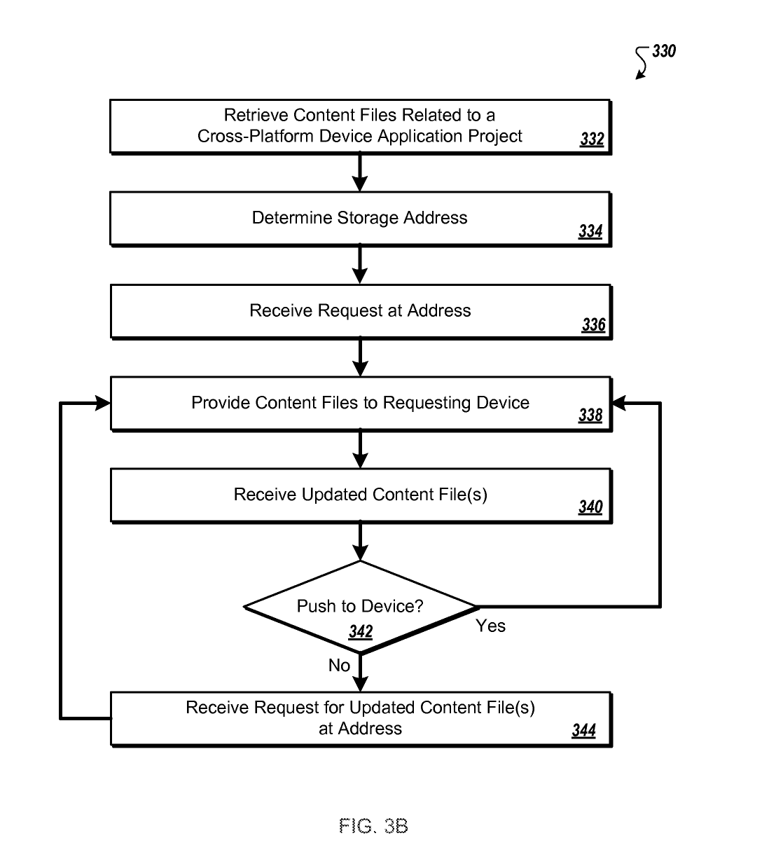

Turning to FIG. 3A, a flow chart illustrates a method 300 that may be used, in some implementations, for developing a cross-platform software application. In some implementations, the method 300 may begin with receiving a set of content files related to a cross-platform software application project (302). In some implementations, the content files may be provided as information to be interpreted by a platform-specific development application during run-time. For example, the content files may include presentation files and media files configured to present an application graphical user interface via a browser engine feature (e.g., within a “windowless” browser application) executing on a target computing device. In some implementations, the content files may be uploaded to a networked environment such as an integrated cloud environment for generating one or more platform-specific application executable files incorporating the set of content files. In addition to the content files, in some implementations, other files or intformation may be received such as, in some examples, information regarding target computing device platforms for generation of the platform-specific application executable files, media or other files for compile-time inclusion with wireless computing device application code (e.g., an image to be used as an application icon, etc.), information regarding a particular project or developer registered to use the integrated cloud environment for development of cross-platform software applications, and registration information, provision information, or certificate information presenting proof that the developer is authorized to develop computing device applications for one or more particular computing device platforms. In some implementations, one or more other files may be identified as compile-time files rather than interpretation files based upon, in some examples, name, metadata, or file structure position.

The purpose and use of the content files and any other files, in some implementations, may be derived in part through a directory structure of the abstraction layer used to map the cross-platform software application to platform-specific commands for accessing device features (e.g., sensors, input/output elements, etc.). For example, to develop an application using the Apache Cordova abstraction layer, content files may be provided in the “www” file directory. In some implementations, the directory structure of the abstraction layer may be presented, in part, in the development environment accessed by the developer when creating the cross-platform software application.

For each target computing device platform (308), in some implementations, the content files may be combined with platform-specific files that are platform-specific to a particular target computing device platform to create a set of project files for the target computing device platform (304). In some implementations, the platform-specific files may include platform-specific libraries to enable art abstraction layer for interfacing with device features (e.g., sensors, input/output elements, etc.) to communicate with a particular computing device platform. In some implementations, the platform-specific files may be obtained from a software development kit (SDK) for creating computing device applications for a particular computing device platform. For example, one or more platform-specific SDKs may be deployed, in whole or in part, in a network cloud environment for generating platform-specific software application executables based on cross-platform software application files.

Additionally, in some implementations, the content files may be combined with other cross-platform files to enable functionality of the cross-platform software application. For example, the content files may be combined with libraries, abstraction layers, or other constructs to support the functionality of the cross-platform software application upon one or more computing device platforms. In a particular example, the content files may be copied into a directory structure incorporating the Apache Cordova platform.

In some implementations, an update agent may also be merged with the project files to enable updating the platform-specific development application when installed on the target computing device (306). The update agent, in some implementations, may include one or more algorithms for providing an identification mechanism used by a development computing device to identify the platform-specific development application executing on a target computing device. In some implementations, the update agent may include one or more algorithms for establishing a file sharing connection between the target computing device and the development computing device for receiving updated content files from the development computing device. The update agent may include, in some implementations, one or more algorithms for monitoring a directory, such as a content file directory or a temporary directory, for updated or new files pushed to the target computing device from the development computing device.

For each target computing device platform (314), in some implementations, the project files may be compiled to create a respective platform-specific development application executable file for a target computing device platform (310). In some implementations, a platform-specific development application executable file (e.g., installation executable file) may be generated in an integrated cloud environment using portions of a platform-specific SDK. For example, compile and build operations provided through platform-specific SDKs may be accessed via a cloud network to compile and build the platform-specific development application executable file.

For each target computing device platform (314), furthermore, in some implementations, a digital signature may be added to the development application executable file for a particular target computing device platform (312). In some implementations, a code signing technique may be used by a computing device platform to ensure integrity of the code. For example, a digital signature may be applied to a platform-specific development executable file to allow a target computing device configured with that computing device platform to authenticate the source (e.g., developer, company, etc.) of the application code. In some implementations, a digital signature may be applied to a platform-specific development application executable file to provide information to the target computing device regarding an intent associated with the code. The intent, in some implementations, may include which device capabilities are accessed by the platform-specific development application (e.g., geolocation, Wi-Fi™, etc.). The intent, for example, may be presented to the user to inform the user of the access supplied to the platform-specific development application to enable the functionality of the platform-specific development application. In a particular example, Apple iOS™ may accept a mobile provision file including a statement of intent and an authenticated developer certificate.

In some implementations, metadata provided by the developer may be used to encode the executable with a digital signature. In some examples, a provision or certificate may be supplied to a developer based upon an application a developer submitted with a request to develop a new computing device application on a particular computing device platform. Information regarding the provision or certificate, or, in some implementations, the provision or certificate itself may be supplied to the integrated cloud environment for inclusion in the platform-specific development application executable file.

In some implementations, the platform-specific development application executable file(s) may be provided to the development computing device (316). For example, the integrated cloud environment may upload the development application executable file(s) to a directory on the target computing device. In some implementations, the platform-specific development application executable file(s) may be placed in a temporary directory. In other implementations, the developer may request download of the platform-specific development application executable files.

In some implementations, the content files may be stored in a version-controlled project directory (318). For example, multiple versions of the content files may be maintained in the integrated cloud environment for rolling back to a previous stage of development or for sharing with additional developers in a team. In some implementations, the project files and/or the platform-specific development application executable file(s) may be stored in the version-controlled project directory as well. In some implementations, digital signature data, such as provision or certificate data, may be maintained in the project directory. In other implementations, copies of provision or certificate data may be deleted after inclusion as a digital signature, for example to protect the developer against theft and misuse of the digital signature data.

Turning to FIG. 3B, a flow chart illustrates a method 330 that may be used, in some implementations, for developing a cross-platform software application. In some implementations, the method 330 may begin with retrieving a set of content files related to a cross-platform software application project (332). In some implementations, the content files may be provided as information to be interpreted by a platform-specific development application during run-time. For example, the content files may include presentation files and media files configured to present an application graphical user interface via a browser engine feature (e.g., within a “windowless” browser application) executing on a target computing device. In addition to the content files, in some implementations, other files or information may be received such as, in some examples, information regarding target computing device platforms for generation of the platform-specific application executable files, media or other files for compile-time inclusion with development application code (e.g., an image to be used as an application icon, etc.), information regarding a particular project or developer registered to use the integrated cloud environment for development of cross-platform software applications, and registration information, provision information, or certificate information presenting proof that the developer is authorized to develop software applications for one or more particular computing device platforms. In some implementations, one or more other files may be identified as compile-time files rather than interpretation files based upon, in some examples, name, metadata, or file structure position.

The purpose and use of the content files and any other files, in some implementations may be derived in part through a directory structure of the abstraction layer used to map the cross-platform software application to platform-specific commands for accessing device features (e.g., sensors, input/output elements, etc.). For example, to develop an application using the Apache Cordova abstraction layer, content files may be provided in the “www” file directory. In some implementations, the directory structure of the abstraction layer may be presented, in part, in the development environment accessed by the developer when creating the cross-platform software application.

In some implementations, a storage address may be determined (334). For example, a network location or URL may be identified for providing the content files to a networked target computing device. The storage address, in some implementations, may be an address accessible only to known target computing devices (e.g., unique identifier recognized) or by a requestor having identification information (e.g. user identification, password, etc.) recognized by a security element of the integrated cloud environment.

In some implementations, a request may be received at the storage address (336). In some implementations, the request may be for download of one or more content files. The request, in some implementations, may be received by a known or identifiable target computing device. The user of the target computing device, in some implementations, may provide authentication information prior to being allowed to download the content files.

In some implementations, the content files may be provided to the requesting target computing device (338). For example, upon authentication of the target computing device or user information provided by the target computing device, one or more content files may be downloaded to the target computing device.

At a later point in time, in some implementations, updates to the content files may be received (340). For example, a developer may make changes to a project within a development client application. The updated content files, in some implementations, may be made available for download by one or more target computing devices.

If a particular target computing device is configured for automatic receipt of updated content files (342), in some implementations, content files may be pushed to the target computing device (338). For example, using an established network connection, the content files may be automatically provided to the target computing device. In some implementations, a companion application executing upon the target computing device may establish a content file sharing connection with an integrated cloud environment.

Otherwise, in some implementations, a request for the updated content files may be received at a storage address (344). In some implementations, the storage address may be the same as the storage address initially determined (334) for providing the content files related to the cross-platform software application project. The storage address, in some implementations, may be determined and provided to a developer, for example as a QR code, URL, or text message, upon a display area of a target computing device. The content files may be downloaded to the target computing device, in some implementations, from the storage address.

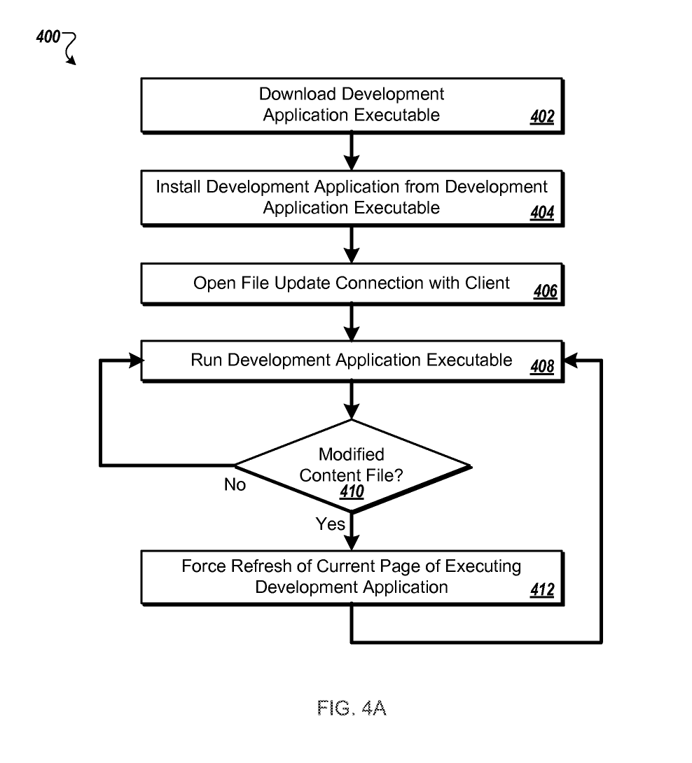

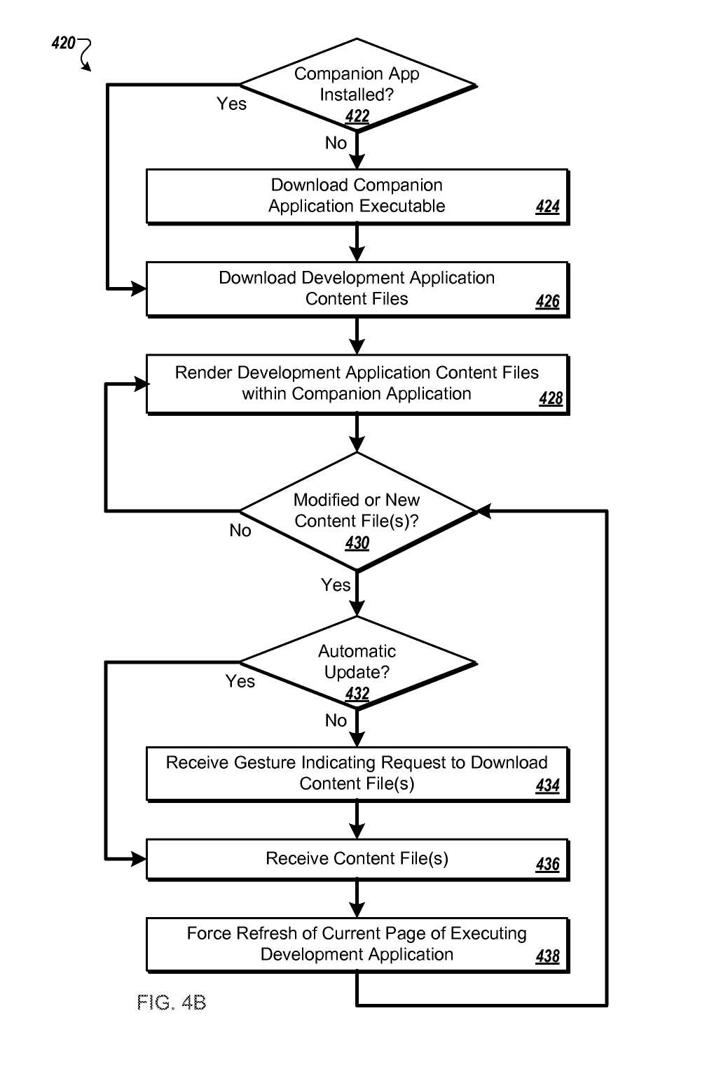

FIG. 4A illustrates a flow chart of a method 400 that may be used, in some implementations, for performing partial updates of a development version of a cross-platform software application. In some implementations, the method 400 may begin with downloading a development application executable (402). The development application executable, in some implementations, may be used to install a development application compiled with an update agent feature for automatically updating content files while testing the development application on a target computing device. In some implementations, the development application executable may be pushed to a tethered target computing device from a development computing device. In other implementations, the development application executable may be pushed to a target computing device from a development computing device over a wireless network connection.

In some implementations, the development application executable may be executed to install a development application (404). The development application, in some implementations, may include a interface generated using a browser engine feature (e.g., “windowless” browser interface) that interprets user interface instructions from a set of presentation files. The presentation files, in some implementations, may be installed in a content file directory coded into the development application.

In some implementations, a file update connection may be opened with a development computing device (406). In some implementations, the update agent feature of the development application may communicate with a development computing device to establish a file sharing connection. The update agent, in some implementations, may transmit or otherwise make available to the development computing device a unique identifier identifying the development application compiled to run upon the target computing device.

In some implementations, the development application may be running (408). For example, a developer may be directly interacting or causing interactions (e.g., feeding test input to the target computing device) with the development application.

In some implementations, a content file may be modified (410). While testing the development application upon a target computing device, in some implementations, a developer may discover a problem with the performance of the development application. In some implementations, the developer may update one or more content files to alter the performance of the development application and push the updated content file(s) to the target computing device. For example, the developer may change a position of a control in the user interface of the development application. Upon selecting a save control in a development client application user interface, in some implementations, the updated content file(s) may be automatically pushed to one or more target computing devices running the development application with the update agent feature. In some implementations, a developer may actively select a control instructing the development client application to push the content file(s) to the target computing device.

In some implementations, the update agent functioning on the target computing device may accept the transfer of the one or more content files. The content files, in some implementations, may be pushed to a content file directory (e.g., a directory being used by the development application for interpreting user interface information). In some implementations, the content file(s) may be pushed to a temporary directory. For example, the update agent may recognize receipt of one or more updated content files and move the updated content files into the content file directory read from by the development application. In some implementations, rather than receiving only an updated content file, the development client application may push an updated presentation file and a new content file (e.g., linked into the updated presentation file through an inclusion statement in the script language, etc.) to the target computing device.

In some implementations, the current page (e.g., view, user interface image, etc.) of the executing development application may be forced to refresh in response to the receipt of the modified content file (412). In some implementations, the update agent may include an algorithm for refreshing the user interface of the development application while the development application continues to run from the same point. For example, if a presentation file has been updated to move a position of a control on a view of the user interface that is currently displayed, the refresh of the page may cause immediate display of the new position of the control within the user interface. In this manner, in some implementations, modifications to the behavior of the development application may be made without causing a noticeable delay in or restart of the functionality of the development application. In other implementations, the update agent may stop or suspend the development application while the content files are being updated, then restart the development application or reload the development application to begin using the updated content files.

FIG. 4B illustrates a flow chart of a method 420 that may be used, in some implementations, for performing partial updates of a development version of a cross-platform software application. In some implementations, the method 420 may begin with determining whether a companion application has been installed upon a target computing device (422). If, in some implementations, a companion application installation file, application file, or other indicator is not located upon the target computing device, the companion application installation executable may be downloaded (424). In some implementations, the companion application installation executable may be downloaded from an application store, for example by browsing or searching for the companion application from the target computing device. In some implementations, the companion application installation executable may be accessed at a network storage location. For example, a URL may be provided with information on downloading the companion application installation executable. The storage location, in some examples, may be provided within a QR code or text rendered to a display region of a development computing device and/or the target computing device.

The companion application, in some implementations, may include a windowless browser functionality configured to render content files of a cross-platform software application. The windowless browser functionality, in some implementations, may further include an abstraction layer library to enable calls to features, input/output elements, sensors, and/or peripheral devices included in a particular computing device platform. For example, Apache Cordova may be included to provide access to features of a computing device platform. The content files rendered within the windowless browser may, in some implementations, include calls to generic functions available using the abstraction layer. In some examples, generic functions may be mapped to specific sensor devices, input/output devices, or other features of individual computing device platforms (e.g., through an application programming interface). The generic functions, for example, may provide the opportunity for a developer to interact with these features without knowing specific information regarding the feature as implemented on a per-platform level. For example, the abstraction layer may include generic calls to a speaker element, accelerometer element, global position system (GPS) element, or other element common to many computing devices.

In some implementations, the companion application may include a management feature to manage two or more cross-platform software application projects created in an integrated cloud environment for development of cross-platform software applications. For example, content files related to two or more cross-platform software application projects may be downloaded to the target computing device and managed by the companion application.

The companion application, in some implementations, may include functionality for downloading and managing content files for one or more cross-platform software application projects. For example, the companion application may manage authentication information to authenticate the target computing device with a development server providing the content files. In some implementations, the companion application may track a storage location for downloading content files for each of the managed cross-platform software application projects.

In some implementations, development application content files may be downloaded to the target computing device (426). In some implementations, a QR code rendered to the display area of a target computing device may be scanned, for example using a scanning function of the target computing device, to obtain a download address. In some implementations, the companion application may include functionality for supporting the download of content files from a network storage location. For example, based upon user credentials (e.g., developer user id, password, project name, etc.), the companion application may pull one or more project identifiers as options for download. The companion application, for example, may include a menu illustrating a list of options for downloading content files to the companion application. The content files, in some implementations, may be organized by the companion application upon download. For example, the companion application may create a separate directory for content files related to two or more cross-platform software application projects.

In some implementations, content files of the development application may be rendered within the companion application framework (428). For example, the companion application may supply a windowless browser feature within which content files may be rendered. Furthermore, in some implementations, the companion application may include an abstraction layer library. The abstraction layer library, for example, may enable calls to features, input/output elements, sensors, and/or peripheral devices included in a particular computing device platform. Generic functions available using the abstraction layer, for example, may be mapped to specific sensor devices, input/output devices, or other features of individual computing device platforms (e.g., through an application programming interface), allowing a developer to interact with these features without knowing specific information regarding the feature as implemented on a per-platform level. In some examples, the abstraction layer may include generic calls to a speaker element, accelerometer element, global position system (GPS) element, or other element common to many computing devices.

At a later time, in some implementations, the content files within the integrated cloud environment for development of cross-platform software applications may be modified (430). In some implementations, a developer may make modifications to a cross-platform software application project. The developer, for example, may manually provide one or more content files for provision to one or more target computing devices. In another example, one or more content files may be automatically placed in a storage location for retrieval, for example upon saving the project files.

In some implementations, automatic update may be available upon a target computing device. For example, one or more content files may be added or changed. In some implementations, the companion application may include functionality for monitoring the storage location for modified content files. For example, the companion application may determine that one or more content files differ from the downloaded content files for the presently executing development application. If automatic updating is available (432), the modified content files may be automatically received (436).

If, instead, there is no automatic update option, or if automatic updating is not activated upon the target computing device, in some implementations, a gesture may be received indicating a request to download modified content files (434). A user, in some implementations, may enter a touch screen gesture while executing within the companion application to initiate download of content files for the development application. For example, a user may tap with three fingers and hold for at least one second to initiate download of content files. In other examples, a user may use a particular dragging pattern or tapping pattern to initiate download of content files. In some implementations, during execution of a development application, a developer may enter a menu mode of the companion application to initiate download of content files. For example, the developer may select a menu or option key upon the target computing device to initiate download of content files.

In some implementations, the content files may be received (436). For example, using the previously obtained storage location of the development application content files, the target computing device may download update content files. In some implementations, the companion application may manage the download of the updated content files. For example, the companion application may maintain an indication (e.g., address, etc.) of the storage location for accessing the content files. In some implementations, the companion application may provide authentication information authenticating the target computing device as an authorized recipient of the content files. In some implementations, the entire set of content files may be downloaded to the target computing device. A subset of the content files (e.g., those added and/or changed, in some implementations, may be downloaded to the target computing device.

In some implementations, a refresh of the current page of the executing development application may be forced (438). In some implementations, the companion application may include a refresh feature for refreshing the user interface of the development application while the development application continues to run from the same point. For example, if a presentation file has been updated to move a position of a control on a page of the user interface that is currently displayed, the refresh of the page may cause immediate display of the new position of the control within the user interface. In this manner, in some implementations, modifications to the behavior of the development application may be made without causing a noticeable delay in or restart of the functionality of the development application. In other implementations, the companion application may stop or suspend the development application while the content files are being updated, then restart the development application or reload the development application to begin using the updated content files.

FIGS. 5A through 5H illustrate a series of screen shots of example user interfaces for developing cross-platform software applications. The screen shots, in some implementations, may represent features available to a developer working in a development client application. In some implementations, the screen shots may represent features available to a developer working in a development client application via a web client application. For example, a web client application may be rendered within a Web browser program to provide an interface to a developer using a development client application.

Turning to FIG. 5A, a first screen shot 500, in some implementations, may illustrate a user interface for creating a new cross-platform software application, project for a cross-platform software application. The developer interacting with the first screen shot 500, in some implementations, may be logged into a developer account with an integrated cloud environment for development of cross-platform software applications. In some implementations, the first screen shot 500 may be presented within an Internet browser. The screen shot 500, in some implementations, may be presented as part of a client software application. A menu bar 502 includes a new control 504a and a my projects control 504b. Selection of the new control 504a, in some implementations, may cause presentation of a new project dialog box 506, for example in a main panel 508 of the first screen shot 500. In some implementations, the developer may add a project workspace name within a text input box 510. For example, the project workspace name may be indicative of a type or title of cross-platform software application.

In some implementations, the developer may select a description control 512 to enter a brief description related to the new project. In some implementations, the project name and/or the project description may be provided to the integrated cloud environment to obtain permissions from a computing device platform for development of a new computing device application. For example, certain computing device platforms may involve registration using metadata such as developer biographic information and project information to receive authorization to develop an authenticated application for installation on the computing device platform. In some implementations, the integrated cloud environment may enable the developer to obtain such authorization, for example by pre-configuring request information.

To close the dialog box 506 without creating a new project, in some implementations, the developer may select a cancel control 516. To accept the information contained within the new project dialog box 506, in some implementations, the developer may select an OK control 514. Upon selection of the OK control 514, in some implementations, the integrated cloud environment may generate project content on behalf of the developer such as, in some examples, project metadata, a project directory structure in a local memory and/or a networked file repository, and one or more project files such as basic presentation files for developing a cross-platform software application.

Upon creation of the new project via selection of the OK control 514, in some implementations, the project may be accessible via selection of the my projects control 514b in the menu bar 502.

Turning to FIG. 5B, a second screen shot 520, in some implementations, may illustrate a user interface for opening an existing cross-platform software application project for developing a cross-platform software application. As illustrated in the screen shot 520, the my projects control 504b in the menu bar 502 is selected. An open dialog box 522 may present a first project name 524, “Hello World.” In some implementations, any number of project names may be visible within the open dialog box 522. For example, the developer may select (e.g., mouse over, single click, etc.) the first project name 524 from a list of available project names. In some implementations, the project may have been created using the new dialog box 506 as described in relation to FIG. 5A. In some implementations, the workspace name “Hello World” may have been entered into the text input box 510 of FIG. 5A.

The open dialog box 522 includes a description control 526. In some implementations, the description control 526 may present information entered through the new dialog box 506 (e.g., as described in relation to FIG. 5A upon selection of the description control 512). For example, the description control 526 may be selected to view a brief description related to the selected project (e.g., project name 524 “Hello World”). The brief description, in some implementations, may further include metadata regarding the selected project such as, in some examples, a developer name or identifier, a creation date, a tinmestamp of the last modification made to the project, etc.

In some implementations, a cross-platform software application project may be accessed and modified by two or more developers. For example, a development team may share access to the files contained within the selected project name 524. In this case, for example, metadata associated with the cross-platform software application project may include a list of developers authorized to contribute to the cross-platform software application project. In some implementations, various developers may have various permissions. For example, some developers may have read-only access, while other developers may have read/write access to the files of the selected cross-platform software application project.

To close the dialog box 522 without selecting a cross-platform software application project, in some implementations, the developer may select a cancel control 529. To open the cross-platform software application project selected within the open dialog box 522, in some implementations, the developer may select an OK control 528. Upon selection of the OK control 528, in some implementations, the integrated cloud environment may present the developer with an interface for working with project files related to a cross-platform software application named “Hello World”.

Turning to FIG. 5C, a third screen shot 530, in some implementations, may illustrate a development environment for a developer to create, edit, and simulate a cross-platform software application. As illustrated, the third screen shot 530, in some implementations, may include a menu bar 532 for selecting particular actions such as adding files, saving project content, and running an application, an editing pane 534 for editing content related to a cross-platform software application project, a file navigation pane 536 for organizing and selecting content associated with a cross-platform software application project, and a device pane 538 for adding or selecting a target computing device for testing a development application. To open a different cross-platform software application project or to create a new cross-platform software application project, in some implementations the user may select a home control 546a in the menu bar 532 to return to a main user interface as represented, for example, by FIGS. 5A and 5B.

Beginning with the project navigation pane 536, a project directory “Hello World” 540, in some implementations, may include a presentation files directory 542a, an images file directory 542b, an audio file directory 542c, and a video file directory 542d. In some implementations, the file directories 542 may contain platform-independent files for developing a cross-platform software application. The files contained within the file directories 542, in some implementations, may be combined with platform-specific files to create an installation executable file for download to a particular computing device platform. In some implementations, the platform-specific files may be stored in a cloud network of an integrated cloud environment for developing cross-platform software applications. The cross-platform software application may function, in some examples, by presenting application features through a browser engine feature, such as within a “windowless”, “borderless”, or otherwise “invisible” browser application. For example, the presentation files 542a may be interpreted at run time to present information through the browser engine feature. In some implementations, the browser engine feature may be provided within a “companion” software application. For example, a developer may download and install the companion application upon a target computing device to enable the target computing device as a development device for testing cross-platform software applications. Project files may then be downloaded into the companion application for testing the cross-platform software application. In some implementations, the browser engine feature may be combined with (e.g., compiled with) the presentation files 542, platform-specific files, and other files to create a development application executable.

The presentation, files 542a may link to media items such as images, audio, and/or video, for example stored in the images file directory 542b, audio file directory 542c, and/or video file directory 542d. In some implementations, the presentation files 542a may be developed in a number of presentation file formats such as, in some examples, HTML, JavaScript, and CSS. Files written in two or more presentation file formats, in some implementations, may be linked together to create the cross-platform software application interface and functionality. For example, as illustrated in the third screen shot 530, the presentation files directory 542a includes files 544 written in CSS, JavaScript, and HTML.

A developer, in some implementations, may select one of the files 544 available in the file navigation pane 536, in some implementations, to view and edit the information in the editing pane 534. For example, a style.css file 544d may be selected in the file navigation pane 536, presenting the contents of the style.css file 544d within the editing pane 534. In some implementations, multiple files 544 may be opened within the editing pane 534. For example, the style.css file 544d may appear as a tab within the editing pane 534.

Rather than selecting an existing file 544, in some implementations, a developer may add a new file to the cross-platform software application project. Turning to the menu bar 532, an add control 546b, in some implementations, may be selected to add a new file to the cross-platform software application project. In some implementations, selection of the add control 546b may result in presentation of a dialog interface that may provide options of two or more types of files such as, in some examples, an HTML file, JavaScript file, or CSS file. In some implementations, selection of the add control 546b may result in presentation of a file navigation pane to import one or more files from another cross-platform software application project (e.g., a project created by or visible to the developer), a local hard drive, or another storage location accessible to the development computing device. For example the developer may select the add control 546b to add one or more media files, such as images, audio files, or video files, to the Hello World project.

Turning to the device pane 538 beneath the editing pane 534, one or more devices listed, such as a “My iPad” device 549, may in some implementations be indicative of a number of target computing devices registered by the developer in the development client application. In some implementations, the development client application may recognize one or more target computing devices connected (e.g., wired or wireless) to the development computing device. For example, a target computing device compatible with the development client application (e.g., running on a platform for which the development client application may generate a platform-specific computing device application) may be identified upon being connected to the development computing device. For example, upon connecting a target computing device to the development computing device through a USB port of the development computing device, the development client application may recognize the target computing device and import information regarding the target computing device. In some implementations, the development client application may open a dialog box to provide the developer with a method for specifying a portion of the information regarding the identified target computing device. For example, the development client application may recognize a target computing device model 549a of iPad 1.1, a unique device identifier code 549c, a platform operating system version 549d of 5.0.1, and a platform vendor 549e of Apple®, and a name 549b (e.g., “My iPad”). In some implementations, rather than automatic detection, the development client application may be directed towards locating a connected target computing device. For example, a control in the user interface (not illustrated) may be accessed to instruct the development client application to “find connected device.”

Although illustrated with the device pane 538, in some implementations, during development of the cross-platform software application, the portion of the third screen shot 530 containing the device pane 538 may be replaced with a tool bar which may aid the developer in locating and fixing any syntax and linking errors. For example, a developer may work in the editing pane 534, while a message pane below provides indication of errors as well as, in some implementations, navigational aid in locating potential problems with the code being developed. In some implementations, a control may be provided to the developer to verify syntax and potential link errors within the project files. In some implementations, the project files may be automatically verified, for example upon selection of a save control 546c.

Selection of the save control 546c, in some implementations, may result in replication of the saved file(s) to a network drive, such as a cloud network in communication with the development client application causing presentation of the user interface illustrated by the screen shot 530. For example, the files 544 displayed within the file navigation pane 536 may be remotely located in a cloud network repository. In some implementations, the project files 544 may be stored locally, for example within a hard drive region of a development computing device, during development of the project files 544. In some implementations, files 544 may be uploaded to a cloud network upon selection of a run control 546d. For example, the cross-platform software application files 544 may be uploaded to an integrated cloud environment where the cross-platform software application files 544 may be combined with platform-specific files to generate a development application for deployment upon a particular target computing device platform.

At some point in time, the developer may determine that the project is in condition for testing, for example either on a target computing device or in a simulation. In some implementations, the developer may select the run control 546d to be presented with a set of drop-down menu options 548 including an On Device option 548a and an In Simulator option 548b. The On Device option 548a, when selected, in some implementations, may present to the option of preparing an executable file containing the application for deployment to the iPad™ device 549 listed within the device pane 538. In some implementations, the On Device option 548a, when selected, may present the option of providing a storage location for downloading content files to a companion application installed upon a target computing device such as the iPad™ device 549. As illustrated, the In Simulator option 548b may be highlighted. Upon selection of the In Simulator option 548b, in some implementations, a device simulator may be presented in a display region such as, for some examples, the editing pane 534, a display adjacent to the screen shot 530, a display replacing the screen shot 530, or a display partially overlaying the screen shot 530.

For example, turning to FIG. 5D, a screen shot 551 may be overlaid with a simulator including a simulation control panel 550, a device orientation menu 552, and a smart phone style device simulation 554. The smart phone style device simulation 554, in some implementations, may be presenting a simulation of the “Hello World” cross-platform software application project in a display area 555 of the smart phone style device simulation 554, for example based upon the information contained within the content files 544 listed in the file navigation pane 536. As illustrated, the display 555 features a first message 557a “Find Me!”, a second message 557b “Say Hello!” and a third message 557c “Enter your name:”. In some implementations, the developer may directly interact with the smart phone device simulation 554, for example through selection (e.g., click, mouse-over, etc.) of one of the controls 558. In one example, the developer may select a text box control 558d and type in information, for example using a keyboard connected to the development computing device.

In some implementations, the simulator may be created using a browser engine feature such as a windowless web-browser framework for rendering the interface upon a display region of the development computing device, similar to the functionality of the cross-platform software application running on a target computing device.

In some implementations, the simulator may include functions for intercepting API commands directed towards the abstraction layer for translating presentation file commands to platform-specific computing device commands. In some examples, API commands directed towards sensors, input/output devices, and other device-specific features may be intercepted by the simulator. Conversely, in some implementations, the simulator may include one or more features to provide input that would be generated by device-specific features. In some implementations, the simulation control panel 550 may include access to mechanisms to simulate orientation, geolocation, camera, accelerometer, photo sensor, biometric, and/or other computing device platform features.

In some implementations, upon launching the simulator, the simulation feature may default to a particular type of computing device platform, for example based upon user options set by the developer through the development client application. The type of computing device platform illustrated by the simulator, in some implementations, may be based in part upon the device(s) listed within the device pane 538. For example, if the first device listed were a style of smart phone, or if a highlighted device in the device pane 538 were a smart phone, the simulator may default to displaying a smart phone type device platform. In other implementations, rather than displaying the simulation of the cross-platform software application in a default type of computing device platform, the user interface may include a sub-menu of the In-Simulator menu option 548b (as displayed in FIG. 5C) displaying two or more options of types of computing device platforms available for simulation.

In some implementations, the developer may interact with the smart phone device simulation 554 through the device orientation menu 552. In some implementations, the developer may select a first control 560a to rotate the orientation of the smart phone device simulation 554 by ninety degrees counter-clockwise, a second control 560b to flip the orientation of the smart phone device simulation 554 upside-down, or a third control 560c to rotate the smart phone device simulation 554 ninety degrees clockwise.

In some implementations, the developer may access different interaction mechanisms through the simulation control panel 550. As illustrated, for example, an orientation control 562a may be selected. Beneath the orientation control 562a, a geolocation control 562b, when selected, may replace the device orientation menu 552 with a geolocation menu (as described further in relation to FIG. 5E). At the bottom of the simulation control panel 550, a device selection control 562c, when selected, may provide the developer the opportunity to switch from the smart phone device simulation 554 to a different computing device type or computing device platform simulation such as, in some examples, a tablet computing device simulation, a PDA device simulation, or a multimedia player simulation.

Turning to FIG. 5E, the screen shot 551, in some implementations, may be overlaid by a simulator including the simulation control panel 550, a device geolocation menu 564, and a PDA style device simulation 566. In some implementations, the PDA style device simulation 566 may be selected using the device selection control 562c. For example, upon selection of the device selection control 562c, the developer may be presented with a dialog box for selecting a type of device platform for presentation by the simulator. In some implementations, the PDA style device simulation 566 may be presented based upon the addition of a new device (e.g., a “My Bberry” device 568 as illustrated in the device pane 538).

A display area 570 of the PDA style device simulation 566 may contain similar information as the simulation displayed on the smart phone style device simulation 554 of FIG. 5D. For example, the controls 558 may be arranged in a similar organization in the display area 570 as illustrated on the smart phone style device simulation 554 of FIG. 5D. However, modifications may exist based upon, in some examples, a screen size, relative screen dimensions, screen resolution, color depth, available system fonts, or other system differences inherent between a smart phone style device and a PDA style device. For example, the PDA style device simulation 566 appears to have a much smaller screen area than the smart phone style device simulation 554 (e.g., as shown in FIG. 5D). In some implementations, a developer may review the functionality upon simulations of various computing device types to verify that rendering appears appropriate from device to device (e.g., no overlapping, difficult to read, or partially off-screen information, etc.).

The display area 570 of the PDA style device simulation 566 may contain an activation control 558c next to the first message 557a (“Find Me!”). In some implementations, selection of the activation control 558c may activate a geolocation feature of a simulated computing device, deriving a current location of the simulated computing device. Using the geolocation dialog box 564, in some implementations, a developer may mimic input to one or more geolocation sensors of a simulated computing device. For example, the geolocation dialog box 564 may include positioning input boxes 572, such as a latitude input box 572a, a longitude input box 572b, an altitude input box 572c, an accuracy input box 572d, and a altitude accuracy input box 572e. Additionally, the geolocation box dialog 564 may include movement input boxes 574, such as a speed input box 574a and a heading input box 574b. In some implementations, the geolocation dialog box 564 may include a map 576 to select a particular position. Heading information or map navigation, in some implementations, may be provided using a compass control 578.

Turning to FIG. 5F, the screen shot 551 may be overlaid with a simulator including the simulation control panel 550 and the smart phone style device simulation 554. As illustrated in the display area 555 of the smart phone style device simulation 554, the second message 557b, formerly displaying “Say Hello!” (e.g., as displayed in FIGS. 5D and 5E) may be updated to state “Changes Auto-Update When the File is Saved!” Turning to the menu bar 532, the save control 546c, in some implementations, may be selected to save modifications made to one or more of the content files 544, as illustrated in a drop-down menu 580. In some implementations, while testing the performance of the cross-platform software application in the simulator, the developer may apply modifications to one or more content files 544. For example, the developer may apply one or more changes to the file style.css 544d, open in the editing pane 534 as illustrated in FIG. 5F. Upon saving changes to the file style.css 544d, in some implementations, the simulation of the cross-platform software application may be automatically updated to reflect the change. For example, without resetting or reloading the program, an immediate modification to one or more items illustrated within the display area 555 of the smart phone style device simulation 554, such as the relocation of the controls 558a, 558b, and 558d as well as the third message 557c to provide room for the updated (and much longer) second message 557b, may be provided to the developer in the display area 555. In some implementations, the development client application or a simulation feature within the simulation of the cross-platform software application may perform a screen refresh of the display area of the development computing device to cause immediate regeneration of the display area 555 of the smart phone style device simulation 554.

In some implementations, a similar mechanism may be available for updating a platform-specific version of the cross-platform software application when tested on a target computing device. For example, upon saving one or more changes to one or more content files 544, the development client application or development application (e.g., via the web client application) may push the updated content files to the target computing device, where a platform-specific version of the cross-platform software application may include an update agent or companion application configured to recognize new content files and refresh the display area of the target computing device to present the changes to the developer in near real-time. In another example, the integrated cloud environment may provide the new and/or updated content files for download to a target computing device.

Turning to FIG. 50, to perform such testing of the cross-platform software application, in some implementations, the run control 546d, as illustrated in a screen shot 590, may be selected, and the On Device drop-down menu option 548a may be activated. In some implementations, selection of the On Device drop-down menu option 548a may cause one or more platform-specific application executable files (e.g., executable application file, installation file, etc.) to be generated for download to one or more target computing devices. In some implementations, each target computing device such as, for example, the “My iPad” device 549 and the “My Bberry” device 568 listed in the device pane 538, may be certified, provisioned, or otherwise authorized as a development device by each associated computing device platform. In some implementations, upon selection of the On Device drop-down menu option 548a, application executable files may be generated for all target computing devices listed within the device pane 538. In other implementations, upon selection of the On Device drop-down menu option 548a, application executable files may be generated far any target computing devices selected within the device pane 538 (e.g., both the “My iPad” device 549 and the “My Bberry” device 568, as illustrated in the device pane 538 of FIG. 5G).

In some implementations, generation of the application executable files may occur in an integrated cloud environment. For example, the content files 542 stored in the Hello World project directory 540 may be uploaded to a cloud network and combined with platform-specific files for each target computing device platform. In some implementations, the application executable files may be downloaded to a temporary directory on the development computing device for distribution to the one or more target computing devices.

The application executable files, in some implementations, may be distributed to the target computing devices over a wired connection. In some implementations, the application executable files may be pushed to each target computing device simultaneously, for example over multiple tethered USB connections. In some implementations, the application executable files may be distributed serially to each target computing device, for example over a wired or wireless connection.

In some implementations, a companion application may be installed upon one or more target computing devices. Rather than building an executable file for the target computing devices installed with the companion application, in some implementations, the integrated cloud environment may provide a set of content files for download to the target computing device. For example, the companion application may receive the content files and enable a developer to execute the development application functionality within the companion application shell.

Turning to FIG. 5H, after selection of the On Device drop-down menu option 548a, a pop-up window 592 may overlay the screen shot 590. Within the pop-up window 592, in some implementations, a QR code 594 may be presented along with a message 595 instructing the user to “Scan the following QR code to install the mobile package on your device.” In some implementations, a scanner function of a target computing device may be used to scan the QR code 594 and determine a storage location coded within. Rather than presenting the QR Code 594, in other implementations, text, hyperlink, URL, or other form of presenting a storage location to the display area of the development computing device may be used. In some examples, the storage location may include a network address or URL.

In some implementations, the QR code 594 may include additional information such as, in some examples, an application identifier identifying one or more cross-platform software application projects associated with a developer (e.g. including the project containing the content files), authorized target computing device information (e.g., information uniquely identifying a set of target computing devices provisioned for development by the developer), and authentication information for retrieving the content files. In some implementations, the companion application may be configured to use a portion of the additional information in retrieving the content files from the storage location.

Above the QR code 594, as illustrated within the pop-up window 592, a drop-down menu 596, in some implementations, may provide the user with an opportunity to select a target computing device platform for the development application. In some implementations, one or more platform-specific files may be provided. By providing a target computing device platform via the drop-down menu 596, the developer may ensure that any platform-specific files are available at the storage location coded into the QR code 594. In some implementations, the developer may set the selected target computing device platform within the drop-down menu 596 as a default build platform, for example by selecting a check box 597.

Beneath the QR code 594, as illustrated within the pop-up window 592, a set of hyperlinks 598, 599, in some implementations, may provide the user with additional options for configuring a target computing device as a test device tor the development application. In some implementations, a first hyperlink 598 labeled “I want to use provisions,” when selected, may present the user with the opportunity to build a development application executable for provision to one or more target computing devices, as previously described.

In some implementations, a second hyperlink 599 labeled “I don't have the companion app installed,” when selected, may present the user with instructions on how to access and install the companion application. In some implementations, the user may be presented with a QR code (not illustrated) containing a storage location of the companion application. The user, in other implementations, may be presented with one or more hyperlinks, URLs, or other storage location information to retrieve a copy of a companion application installation executable.

Returning to FIG. 5G, while the development application is running on each of the target computing devices, in some implementations, the developer may update one or more of the presentation files 544. In some implementations, the developer may add a new content file and link it into one of the existing presentation flies 544.

Updates of and/or additions to the content files, in some implementations, may be pushed to each of the target computing devices running the development application including the update agent. In some implementations, updates to and/or additions of one or more content files may be pushed to the target computing devices automatically, for example upon saving the content file(s) using the Save control 546c. In some implementations, only those target computing devices selected within the device pane 538 may have content files pushed to them automatically through selection of the Save control 546c. In some implementations, updates to one or more of the content files may be pushed to a selected target computing device 549, 568 through a manual effort by the developer (e.g., by right clicking on the selected target computing device(s) and selecting a menu option for sending updated content files). In a particular example, a modification to file style.css 544d may be simultaneously pushed to both the “My iPad” device 549 and the “My Bberry” device 568 over a wired or wireless connection. In some implementations, if one of the target computing devices is not physically connected to the development computing device, the target computing device may be recognized on a wireless network by the development client application by a unique identifier built into the platform-specific development application.

Updates of and/or additions to the content files, in some implementations, may be downloaded to each of the target computing devices running the companion application, for example via the integrated cloud environment. In some implementations, one or more of the content files may be transferred to a storage location for download to a target computing device. For example, the updated and/or added content files may be transferred to the storage location initially used to supply the content files to the target computing device(s). In some implementations, a storage location may be communicated to the developer or the companion application executing upon a target computing device. For example, a QR code including the storage location may be supplied to a display region of the development computing device as previously described in relation to FIG. 5H.

In some implementations, a user may manually request download of the content files. For example, a manual request may be submitted via the user interface of a target computing device. For example, the user may input a gesture, such as a particular touch pattern or sweep pattern, to initiate download of updated content files to the target computing device. In another example, the user may select a control upon a target computing device to obtain a menu option that, when selected, may initiate download of the content files.

In some implementations, the content files may be pushed to the target computing device. For example, the companion application may include a feature for monitoring a storage location for updated content files. Upon recognition of the updated content files, for example, the companion application may automatically retrieve the content files.

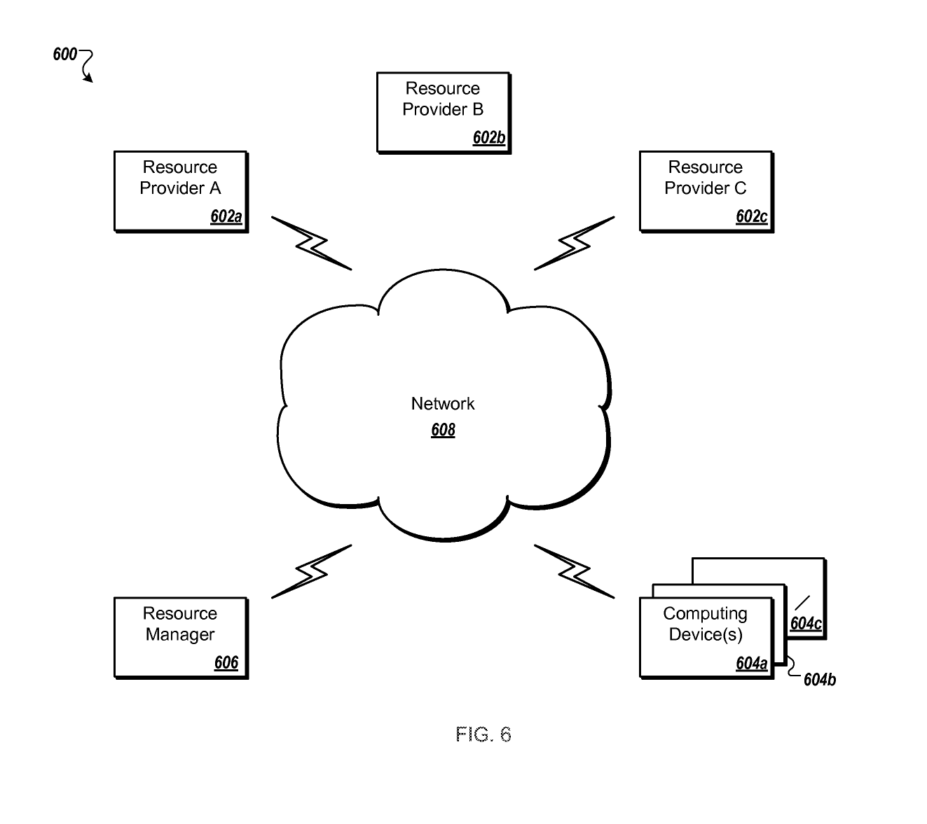

As shown in FIG. 6, an implementation of an exemplary cloud computing environment 600 for development of cross-platform software applications is shown and described. The cloud computing environment 600 may include one or more resource providers 602a, 602b, 602c (collectively, 602). Each resource provider 602 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 602 may be connected to any other resource provider 602 in the cloud computing environment 600. In some implementations, the resource providers 602 may be connected over a computer network 608. Each resource provider 602 may be connected to one or more computing device 604a, 604b, 604c (collectively, 604), over the computer network 608

The cloud computing environment 600 may include a resource manager 606. The resource manager 606 may be connected to the resource providers 602 and the computing devices 604 over the computer network 608. In some implementations, the resource manager 606 may facilitate the provision of computing resources by one or more resource providers 602 to one or more computing devices 604. The resource manager 606 may receive a request for a computing resource from a particular computing device 604. The resource manager 606 may identify one or more resource providers 602 capable of providing the computing resource requested by the computing device 604. The resource manager 606 may select a resource provider 602 to provide the computing resource. The resource manager 606 may facilitate a connection between the resource provider 602 and a particular computing device 604. In some implementations, the resource manager 606 may establish a connection between a particular resource provider 602 and a particular computing device 604. In some implementations, the resource manager 606 may redirect a particular computing device 604 to a particular resource provider 602 with the requested computing resource.

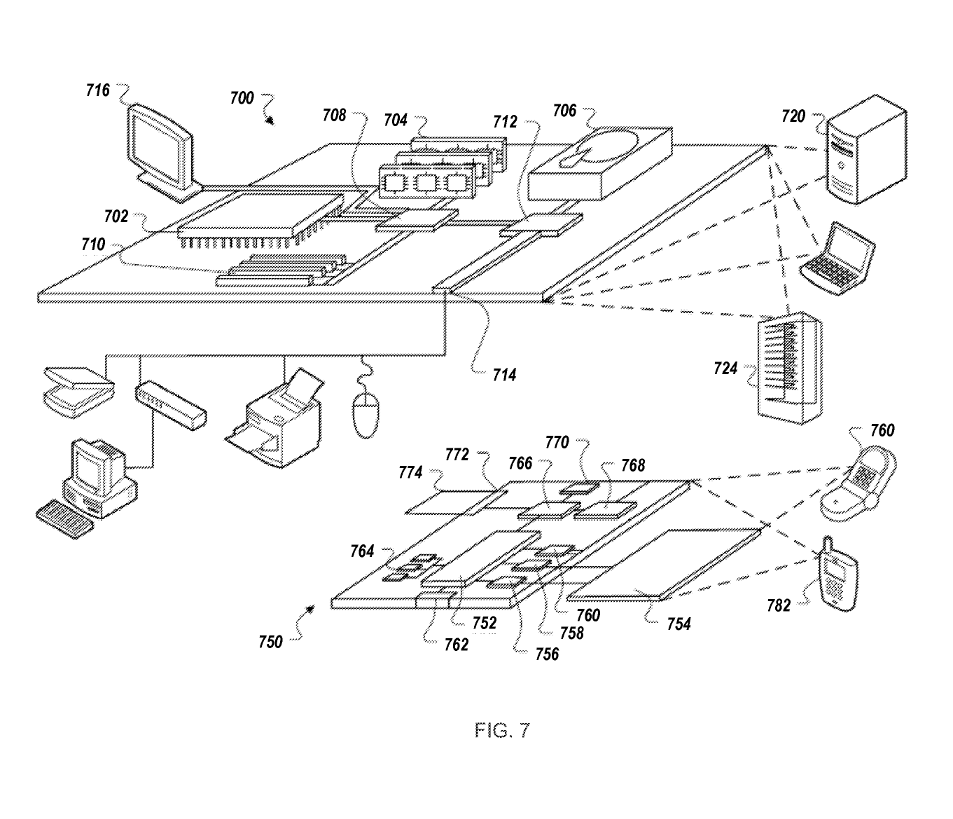

FIG. 7 shows an example of a computing device 700 and a mobile computing device 750 that can be used to implement the techniques described in this disclosure. The computing device 700 is intended to represent various forms of digital computers, such as laptops, desktops, workstations, personal digital assistants, servers, blade servers, mainframes, and other appropriate computers. The mobile computing device 750 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 700 includes a processor 702, a memory 704, a storage device 706, a high-speed interface 708 connecting to the memory 704 and multiple high-speed expansion ports 710, and a low-speed interface 712 connecting to a low-speed expansion port 714 and the storage device 706. Each of the processor 702, the memory 704, the storage device 706, the high-speed interface 708, the high-speed expansion ports 710, and the low-speed interface 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as a display 716 coupled to the high-speed interface 708. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 704 stores information within the computing device 700. In some implementations, the memory 704 is a volatile memory unit or units. In some implementations, the memory 704 is a non-volatile memory unit or units. The memory 704 may also be another form of computer-readable medium, such as a magnetic or optical disk.

The storage device 706 is capable of providing mass storage for the computing device 700. In some implementations, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 702), perform one or more methods, such as those described above. The instructions can also be stored by one or more storage devices such as computer- or machine-readable mediums (for example, the memory 704, the storage device 706, or memory on the processor 702).

The high-speed interface 708 manages bandwidth-intensive operations for the computing device 700, while the low-speed interface 712 manages lower bandwidth-intensive operations. Such allocation of functions is an example only. In some implementations, the high-speed interface 708 is coupled to the memory 704, the display 716 (e.g., through a graphics processor or accelerator), and to the high-speed expansion ports 710, which may accept various expansion cards (not shown). In the implementation, the low-speed interface 712 is coupled to the storage device 706 and the low-speed expansion port 714. The low-speed expansion port 714, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. In addition, it may be implemented in a personal computer such as a laptop computer 722. It may also be implemented as part of a rack server system 724. Alternatively, components from the computing device 700 may be combined with other components in a mobile device (not shown), such as a mobile computing device 750. Each of such devices may contain one or more of the computing device 700 and the mobile computing device 750, and an entire system may be made up of multiple computing devices communicating with each other.

The mobile computing device 750 includes a processor 752, a memory 764, an input/output device such as a display 754, a communication interface 766, and a transceiver 768, among other components. The mobile computing device 750 may also be provided with a storage device, such as a micro-drive or other device, to provide additional storage. Each of the processor 752, the memory 764, the display 754, the communication interface 766, and the transceiver 768, are interconnected using various buses, and several of the components may be mounted on a common motherboard or in other manners as appropriate.

The processor 752 can execute instructions within the mobile computing device 750, including instructions stored in the memory 764. The processor 752 may be implemented as a chipset of chips that include separate and multiple analog and digital processors. The processor 752 may provide, for example, for coordination of the other components of the mobile computing device 750, such as control of user interfaces, applications run by the mobile computing device 750, and wireless communication by the mobile computing device 750.

The processor 752 may communicate with a user through a control interface 758 and a display interface 756 coupled to the display 754. The display 754 may be, for example, a TFT (Thin-Film-Transistor Liquid Crystal Display) display or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may provide communication with the processor 752, so as to enable near area communication of the mobile computing device 750 with other devices. The external interface 762 may provide, for example, for wired communication in some implementations, or for wireless communication in other implementations, and multiple interfaces may also be used.

The memory 764 stores information within the mobile computing device 750. The memory 764 can be implemented as one or more of a computer-readable medium or media, a volatile memory unit or units, or a non-volatile memory unit or units. An expansion memory 774 may also be provided and connected to the mobile computing device 750 through an expansion interface 772, which may include, for example, a SIMM (Single In Line Memory Module) card interface. The expansion memory 774 may provide extra storage space for the mobile computing device 750, or may also store applications or other information for the mobile computing device 750. Specifically, the expansion memory 774 may include instructions to carry out or supplement the processes described above, and may include secure information also. Thus, for example, the expansion memory 774 may be provide as a security module for the mobile computing device 750, and may be programmed with instructions that permit secure use of the mobile computing device 750. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier, that the instructions, when executed by one or more processing devices (for example, processor 752), perform one or more methods, such as those described above. The instructions can also be stored by one or more storage devices, such as one or more computer- or machine-readable mediums (for example, the memory 764, the expansion memory 774, or memory on the processor 752). In some implementations, the instructions can be received in a propagated signal, for example, over the transceiver 768 or the external interface 762.

The mobile computing device 750 may communicate wirelessly through the communication interface 766, which may include digital signal processing circuitry where necessary. The communication interface 766 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 768 using a radio-frequency. In addition, short-range communication may occur, such as using a Bluetooth®, Wi-Fi™, or other such transceiver (not shown). In addition, a GPS (Global Positioning System) receiver module 770 may provide additional navigation- and location-related wireless data to the mobile computing device 750, which may be used as appropriate by applications running on the mobile computing device 750.

The mobile computing device 750 may also communicate audibly using an audio codec 760, which may receive spoken information from a user and convert it to usable digital information. The audio codec 760 may likewise generate audible sound for a user, such as through a speaker, e.g., in a handset of the mobile computing device 750. Such sound may include sound from voice telephone calls, may include recorded sound (e.g., voice messages, music files, etc.) and may also include sound generated by applications operating on the mobile computing device 750.

The mobile computing device 750 may be implemented in a number of different forms, as shown in the figure. For example, it may be implemented as a cellular telephone 780. It may also be implemented as part of a smart-phone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, environments and methods for developing cross-platform software applications are provided. Having described certain implementations of methods and apparatus for supporting the development and testing of software applications for wireless computing devices, it will now become apparent to one of skill in the art that other implementations incorporating the concepts of the disclosure may be used. Therefore, the disclosure should not be limited to certain implementations, but rather should be limited only by the spirit and scope of the following claims.

What is claimed:

1. A method comprising:
obtaining, by a processor of a computing device, a plurality of content files, wherein
the content files comprise one or more presentation files, wherein each presentation file of the one or more presentation files comprises respective instructions which, when interpreted at runtime by a processor of a separate computing device, are configured to provide at least one of (a) a functionality and (b) a user interface of a software application executing upon the separate computing device;
providing the content files to the separate computing device;
after providing the content files:
identifying, by the processor of the computing device, a change in at least a first presentation file of the plurality of presentation files, and
providing at least the first presentation file to the separate computing device, wherein the software application is configured to execute the first presentation file as at least one of (a) the functionality and (b) the user interface of the software application without need for re-installing or re-loading the software application on the separate computing device.

2. The method of claim 1, wherein the content files further comprise one or more media files.

3. The method of claim 1, wherein the respective instructions, when interpreted at runtime, are configured to provide the user interface of the software application within a browser application.

4. The method of claim 3, wherein the browser application is configured to be invisible to the user.

5. The method of claim 1, wherein providing the content files comprises pushing the content files to the separate computing device from the computing device via a wireless connection.

6. The method of claim 1, wherein providing the content files comprises uploading, to a network storage region accessible to the separate computing device, the content files.

7. The method of claim 1, wherein providing the content files comprises providing, for download, an installation executable containing the content files.

8. The method of claim 7, wherein the installation executable comprises a windowless browser application.

9. The method of claim 7, wherein the installation executable comprises an update agent, wherein the update agent is configured, during execution of the software application, to:
receive one or more additional content files, wherein at least one of the one or more additional content files comprises a replacement file for a first content file of the content files, and
replace the first content file with the replacement file.

10. The method of claim 9, wherein the update agent is further configured to, after replacing the first content file with the replacement file, refresh a current user interface of the software application to utilize the replacement file.

11. The method of claim 1, further comprising presenting a simulation of the software application within a mobile device simulator, wherein the mobile device simulator interprets the instructions of at least one of the one or more presentation files to simulate functionality of the software application upon a mobile device.

12. The method of claim 11, wherein the mobile device simulator comprises
one or more controls, wherein the one or more controls, when activated by a user of the computing device, are configured to supply input to the software application.

13. The method of claim 12, further comprising:
receiving, via a first control of the one or more controls, an orientation input; and
responsive to the orientation input, changing an orientation of a display portion of the mobile device simulator.

14. The method of claim 12, further comprising:
receiving, via a first control of the one or more controls, a device type input; and
responsive to the device type input, modifying an appearance of the device simulator, wherein the device simulator comprises a mobile device frame and a display area.

15. The method of claim 14, further comprising responsive to the device type input, refreshing a current user interface presented by the mobile device simulator.

16. The method of claim 11, further composing
identifying, by the processor of the computing device, a change in at least a second presentation file of the plurality of presentation files, and
refreshing a current user interface presented by the mobile device simulator to include information from the second presentation f-tile.

17. The method of claim 1, wherein providing the first presentation file to the separate computing device comprises providing the first presentation file responsive to receiving a request from a user of the computing device.

18. The method of claim 17, wherein the request identifies one or more computing devices, wherein the one or more computing devices comprises the separate computing device.

19. The method of claim 1, further comprising, prior to providing the content files, preparing an installation file comprising the content files.

20. The method of claim 19, wherein preparing the installation file comprises adding a digital signature to the installation file.

21. The method of claim 1, further comprising storing the content files in a version-controlled project directory.

22. The method of claim 1, further comprising receiving, at a storage address, a request for at least the first presentation file, wherein providing the first presentation file comprises providing the first presentation file for download at the storage address.

23. The method of claim 22, wherein the storage address comprises a URL.

24. The method of claim 1, wherein providing the first presentation file comprises opening a file update connection with the second computing device.

25. The method of claim 1, wherein the second computing device executes the software application within a previously installed windowless browser application.

26. A method comprising:
obtaining, by a processor of a computing device, a plurality of content files, wherein the content files comprise one or more presentation files; and
accessing, by a companion application executing on the computing device, the plurality of content files;
interpreting, by the companion application, at least a first presentation file of the one or more presentation files, wherein interpreting the first presentation file comprises rendering at least one of (a) a functionality and (b) a user interface of a software application,
identifying, by the companion application, a request to obtain one or more replacement content files,
responsive to the request, accessing, by the companion application, at least a first replacement presentation file, wherein the first replacement presentation file is configured to replace the first presentation file, and
refreshing, by the companion application, a user interface of the software application to present information interpreted from the first replacement presentation file.

27. The method of claim 26, wherein the request comprises a gesture performed upon a touch screen interface of the separate computing device.

28. The method of claim 26, wherein the request comprises scan data obtained through scanning, by a scan feature of the separate computing device, machine readable indicia.

29. The method of claim 28, wherein the scan data comprises a network address.

30. The method of claim 26, wherein accessing the replacement presentation file comprises accessing a network address to obtain the replacement presentation file.

31. The method of claim 26, wherein the companion application comprises a windowless browser, wherein the user interface of the software application is rendered within the windowless browser.

32. A system comprising:
a processor; and
a non-transitory computer readable medium storing a set of instructions that, when executed by the processor, cause the processor to:
obtain a plurality of content files, wherein
the content files comprise one or more presentation files, wherein each presentation file of the one or more presentation files comprises respective instructions which, when interpreted at runtime by a processor of a separate computing device, are configured to provide at least one of (a) a functionality and (b) a user interface of a software application executing upon the separate computing device;
provide the content files to a plurality of separate computing devices;
after providing the content files:
identify a change in at least a first presentation file of the plurality of presentation files, and
provide at least the first presentation file to at least a first computing device of the plurality of separate computing devices, wherein the software application is configured to execute the first presentation file as at least one of (a) the functionality and (b) the user interface of the software application without need for re-installing or re-loading the software application.

33. The system of claim 32, wherein the first computing device is in communication with the system via a wired connection.

34. The system of claim 32, wherein providing the at least the first presentation file comprises providing the at least first presentation file to a second computing device, wherein the second computing device is in communication with the system via a wireless connection.

35. The system of claim 32, wherein the instructions, when executed, further cause the processor to:
prior to providing the at least first presentation file, identify at least one computing device of the plurality of computing devices on a wireless network, wherein the at least one computing device comprises the first computing device;
wherein providing the first presentation file to the first computing device comprises providing the first presentation file across the wireless network.

36. The system of claim 35, wherein providing the first presentation file to the first computing device comprises opening a file sharing connection with a download agent executing upon the first computing device.

37. The system of claim 32, further comprising an input device, wherein the instructions, when executed, further cause the processor to:
prior to providing the at least first presentation file, receive, via the input device, an indication of at least one computing device of the plurality computing devices, wherein
the at least one computing device includes the first computing device, and
providing the first presentation file comprises providing the first presentation file, responsive to the indication, to the at least one computing device.

38. A non-transitory computer readable medium storing a set of instructions that, when executed by a processor, cause the processor to:
obtain a plurality of content files, wherein
the content files comprise one or more presentation files, wherein each presentation file of the one or more presentation files comprises respective instructions which, when interpreted at runtime by a processor of a separate computing device, are configured to provide at least one of (a) a functionality and (b) a user interface of a software application executing upon the separate computing device;
provide the content files to the separate computing device;
after providing the content files:
identify a change in at least a first presentation file of the plurality of presentation files, and
provide at least the first presentation file to the separate computing device, wherein the software application is configured to execute the first presentation file as at least one of (a) the functionality and (b) the user interface of the software application without need for re-installing or re-loading the software application on the separate computing device.

39. The computer readable medium of claim 38, wherein obtaining the plurality of content files comprises obtaining at least a portion of the plurality of content files, via a network, from a remote computing device.

40. The computer readable medium of claim 39, wherein the instructions, when executed, further cause the processor to, responsive to identifying the change in the first presentation file, cause replication of the first presentation file in a storage repository accessible to the remote computing device.

41. The computer readable medium of claim 39, wherein providing the first presentation file to the separate computing device comprises causing the first presentation file to be accessible to the separate computing device via the network.
